(19) United States
(12) Patent Application Publication
(10) Pub. No.: US 2023/0281464 A1
(43) Pub. Date: Sep. 7, 2023

(54) MULTI-OBJECTIVE OPTIMIZATION OF MACHINE LEARNING PIPELINES

(71) Applicant: INTERNATIONAL BUSINESS MACHINES CORPORATION, Armonk, NY (US)

(72) Inventors: Vaibhav Saxena, New Delhi (IN); Anamitra Roy Choudhury, New Delhi (IN); Aswin Kannan, Berlin (DE)

(21) Appl. No.: 17/653,583

(22) Filed: Mar. 4, 2022

(51) Int. Cl. G06N 3/12

(52) U.S. Cl. CPC G06N 3/126

(57) ABSTRACT

A system, program product, and method for performing multi-objective automated machine learning. The method includes selecting two or more objectives from a plurality of objectives to be optimized and injecting data and the objectives into a first machine learning (ML) pipeline. The first ML pipeline includes one or more data transformation stages in communication with a modeling stage. The method also includes executing, subject to the injecting, optimization of the two or objectives. Such executing includes selecting a respective algorithm for each of the data transformation stages and the modeling stage. Each respective algorithm is associated with a first set of respective hyperparameters. The executing also includes generating a plurality of second ML pipelines. Each second ML pipeline defines a Pareto-optimal solution of the two or more objectives, thereby defining a plurality of Pareto-optimal solutions, The executing also includes selecting one Pareto-optimal solution from the plurality of Pareto-optimal solutions.

### BACKGROUND

The present disclosure relates to performing multi-objective automated machine learning, and, more specifically, to execute the multi-objective automated machine learning over an entire machine learning pipeline for a dataset and multiple objectives of interest.

At least some known machine learning systems are configured to solve problems or resolve queries presented to them through optimizing a single objective. However, many problems and queries include more than one objective, and in some instances, the objectives may conflict with each other. Therefore, a potential solution for each individual objective may be generated, where only the single identified objective is sufficiently optimized, while the other objectives may, or may not, be optimized. At least some additional known machine learning systems are configured to solve problems or resolve queries presented to them through optimizing multiple objectives. Some of such known machine learning systems identify a plurality of machine learning pipelines as Pareto-optimal solutions to optimize a plurality of objectives. In addition, some of such known multiple objective machine learning systems map multiple objectives to a single objective using some weighted combinations.

### SUMMARY

A system and method are provided for performing multi-objective automated machine learning to optimize a plurality of objectives.

In one aspect, a computer system is provided for performing multi-objective automated machine learning to optimize a plurality of objectives. The system includes one or more processing devices and at least one memory device operably coupled to the one or more processing device. The system also includes a multi-objective joint optimization engine at least partially resident within the one or more memory devices. The multi-objective joint optimization engine is configured to select two or more objectives from a plurality of objectives to be optimized and inject data and the two or more objectives into a first machine learning (ML) pipeline. The first ML pipeline includes one or more data transformation stages in communication with a modeling stage. The multi-objective joint optimization engine is also configured to execute, subject to the injecting, optimization of the two or more objectives. The multi-objective joint optimization engine is further configured to select a respective algorithm for each of the one or more data transformation stages and the modeling stage. Each respective algorithm is associated with a first set of respective hyperparameters. The multi-objective joint optimization engine is also configured to generate, subject to the selecting, a plurality of second ML pipelines. Each second ML pipeline of the plurality of second ML pipelines defines a Pareto-optimal solution of the two or more objectives, thereby defining a plurality of Pareto-optimal solutions. The multi-objective joint optimization engine is further configured to select one Pareto-optimal solution from the plurality of Pareto-optimal solutions.

In another aspect, a computer program product is provided that is embodied on at least one computer readable storage medium having computer executable instructions for performing multi-objective automated machine learning, that when executed cause one or more computing devices to select two or more objectives from a plurality of objectives to be optimized and inject data and the two or more objectives into a first machine learning (ML) pipeline. The first ML pipeline includes one or more data transformation stages in communication with a modeling stage. The computer executable instructions when executed also cause the one or more computing devices to execute, subject to the injecting, optimization of the two or more objectives. The computer executable instructions when executed further cause the one or more computing devices to select a respective algorithm for each of the one or more data transformation stages and the modeling stage. Each respective algorithm is associated with a first set of respective hyperparameters. The computer executable instructions when executed also cause the one or more computing devices to generate, subject to the selecting, a plurality of second ML pipelines. Each second ML pipeline of the plurality of second ML pipelines defines a Pareto-optimal solution of the two or more objectives, thereby defining a plurality of Pareto-optimal solutions. The computer executable instructions when executed further cause the one or more computing devices to select one Pareto-optimal solution from the plurality of Pareto-optimal solutions.

In yet another aspect, a computer-implemented method is provided for performing multi-objective automated machine learning to optimize a plurality of objectives. The method includes selecting two or more objectives from a plurality of objectives to be optimized and injecting data and the two or more objectives into a first machine learning (ML) pipeline. The first ML pipeline includes one or more data transformation stages in communication with a modeling stage. The method also includes executing, subject to the injecting, optimization of the two or more objectives that includes selecting a respective algorithm for each of the one or more data transformation stages and the modeling stage. Each respective algorithm is associated with a first set of respective hyperparameters. The method further includes generating, subject to the selecting, a plurality of second ML pipelines. Each second ML pipeline of the plurality of second ML pipelines defines a Pareto-optimal solution of the two or more objectives, thereby defining a plurality of Pareto-optimal solutions. The method also includes selecting one Pareto-optimal solution from the plurality of Pareto-optimal solutions.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a block schematic diagram illustrating a computer system configured to use multi-objective automated machine learning to optimize a plurality of objectives, in accordance with some embodiments of the present disclosure.

FIG. 2 is a flowchart illustrating a process for performing multi-objective automated machine learning to optimize a plurality of objectives, in accordance with some embodiments of the present disclosure.

FIG. 3 is a block schematic diagram illustrating a Combined Algorithm Selection and Hyperparameter (CASH) optimization process, in accordance with some embodiments of the present disclosure.

FIG. 4A is a flowchart illustrating a process for multi-objective CASH optimization through a ML pipeline refinement tool, in accordance with some embodiments of the present disclosure.

FIG. 4B is continuation of the flowchart shown in FIG. 5A further illustrating a graphical result thereof, in accordance with some embodiments of the present disclosure.

FIG. 5 is a flowchart illustrating a process for multi-objective CASH optimization over an entire ML pipeline search space, in accordance with some embodiments of the present disclosure.

FIG. 6 is a schematic diagram illustrating a process for multi-dimensional conditional constraint reformulation, in accordance with some embodiments of the present disclosure.

FIG. 7A is a block schematic diagram illustrating a complexity portion of the process for multi-dimensional conditional constraint reformulation shown in FIG. 6, through the respective mathematical algorithms, in accordance with some embodiments of the present disclosure.

FIG. 7B is a block schematic diagram illustrating a constraint-relaxed and continuous variable portion of the process for multi-dimensional conditional constraint reformulation through the respective mathematical algorithms, in accordance with some embodiments of the present disclosure.

FIG. 8 is a block schematic diagram illustrating a computing system, in accordance with some embodiments of the present disclosure.

FIG. 9 is a block schematic diagram illustrating a cloud computing environment, in accordance with some embodiments of the present disclosure.

FIG. 10 is a block schematic diagram illustrating a set of functional abstraction model layers provided by the cloud computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to employing multi-objective automated machine learning to optimize a plurality of objectives. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments. In addition, it will be appreciated that, although specific embodiments have been described herein for purposes of illustration, various modifications may be made without departing from the spirit and scope of the embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Many known machine learning (ML) systems are configured to solve problems, resolve queries presented to them, or generate predictions of particular outcomes through optimizing a single objective. Optimization of objectives frequently includes either maximizing or minimizing the results directed toward the objectives. However, many problems and queries include more than one objective, and in some instances, the objectives may conflict with each other. For example, a credit card transaction system may attempt to simultaneously optimize the classification accuracy of distinguishing between legitimate transactions versus fraudulent transactions, while also optimizing the number of false positives (classifying fraudulent transactions as legitimate), and the number of false negatives (classifying legitimate transactions as fraudulent), where the costs of false positives may outweigh the costs of false negatives (typically resulting in customer dissatisfaction with the service). In such an example, it may be desired to maximize the classification accuracy, while minimizing the number of false negatives and false positives.

However, in at least some instances, a business entity may elect to optimize the number of false negatives to the detriment of optimizing the number of false positives. Therefore, a potential solution for each individual objective may be generated, where only the single identified objective is sufficiently optimized, while the other objectives may, or may not, be optimized. Other examples of objectives of interest include fairness in the ML model prediction, model robustness, computing efficiency, or time to generate a prediction, and particular user- or domain-specific objectives. Therefore, the resulting plurality of single objective-based solutions may conflict with each other and attempts to reconcile the multiple solutions to obtain an optimal solution for all objectives may not actually provide the optimized objectives for each as desired. Accordingly, optimization methods considering only a single objective from the plurality of objectives may not provide optimal solution when optimizing a plurality of objectives simultaneously.

In general, multi-objective optimization problems that involve more than one objective function that need to be optimized simultaneously may have a mathematical formulation of:

Min F(x)=[f₁(x),f₂(x), . . . f_{M}(x)],over x=[x₁,x₂, . . . xₙ], (Equation 1)

where F(x) is an expression of one or more objective values extending over a domain of x, and the optimization problem Min F(x) is solved through an algorithm that is configured to determine the solutions yielding minimum values for each f(x), where each f(x) is an objective function, and each x represents an optimization parameter, referred to as a decision vector, and F(x) and each x are vectors. There may be M objective functions and n optimization parameters, where M and n are integers, and in some embodiments, M=n. In general, for a generic multi-objective problem (non-ML specific), the solutions are searched over the set of decision vectors (x) such that each component xᵢ of the decision vector x falls within a feasible region, i.e., a solution space that is the set of all possible points of an optimization problem that satisfy the problem's constraints. A Pareto-optimal solution is defined as that condition where no objective of the optimization problem can be better off without degrading at last one other objective.

Therefore, each Pareto-optimal solution is a decision vector which optimizes F(x), and the decision vectors x are input vectors and F(x) is the output vector. In the case of the multi-objective ML problem that is to be solved, and as described further herein, each decision vector x denotes a ML pipeline determined by the choice of data transformers and ML model together with their hyperparameters. Hyperparameters are parameters that are provided by the user before training the ML model. These hyperparameters are known prior to the initiation of ML model training and remain fixed throughout the model training and are therefore not learned during the ML model training. Therefore, in the ML case, each Pareto-optimal solution denotes a particular unique ML pipeline. For example, referring again to the credit card transaction discussion, it will be desired to minimize overall transactions classification errors (f₁(x)) (or, in other words, maximize transaction classification accuracy), minimize false positive rates (f₂(x)), and minimize false negative rates (f₃(x)).

In addition, the optimization problem may also be subject to conditions such as:

g(x)≤0;h(x)=0; and xᵢ^{lower}<xᵢ<xᵢ^{upper},i=1,2,3, . . . ,n, (Equation 2)

where g(x) and h(x) are independent functions of x and the feasible region of xᵢ is defined with an upper bound and a lower bound. Accordingly, a single objective ML system may not be able to find a solution to the Min F(x) optimization problem because the objective functions f(x) may be mutually exclusive for the bounded set of x and the established conditions, where there is no instance, i.e., solution of decision vectors x that will meet all of the requirements to optimize all three of the objective functions f₁(x), f₂(x), and f₃(x), and three vastly different values of x may result for each of the three individual objective function optimization attempts.

At least some known automated machine learning systems include one or more machine learning pipelines, each ML pipeline defined by one or more transformers and one or more ML models. A sequence of transformers is configured to execute data preparation prior to injection into the one or more ML models. Such data preparation includes, without limitation, data preprocessing, extracting, filtering, backfilling, and creating useful features from raw input data. For example, some of such raw data may be unusable as it is ingested in the respective ML pipeline and will need to be either extracted or modified into a useful form. Also, some data may be missing and will need to be backfilled. Some values may be categorized, e.g., gender which is typically not a numerical value, and the respective model may not be able to work with non-numerical values. Further, some ingested features may not be useful and they can be either dropped or some features may need to be combined to improve the predictive model performance. Some known automatic ML systems execute some form of multi-objective optimization through ML models without considering the full ML pipeline, i.e., the data transformation steps are not included in the optimizations.

The ML models may be one or more of a classifier or a regressor to generate the respective predictions. Some known machine learning systems configured for single objective optimization may lead to sub-optimal machine learning models for multi-objective optimization problems due to the imbalanced nature of the input data or may yield poor values for other objectives due to focus on only a single objective. For example, a classifier optimizing only classification accuracy may make for a poor model selection when the input data has majority of the respective samples from only a single class of interest. The resulting model may yield a good classification accuracy due to bias towards the majority class, but may perform poorly with respect to the other objectives.

Some known mechanisms to perform multi-objective optimization include generating multiple optimization solutions and evaluating the solutions through analyzing the dominance thereof. Specifically, dominance is used to determine the quality of the solutions where a first solution is said to dominate a second solution if the first solution is better than or at least equal to the second solution in all objectives, and the first solution is strictly better than the second solution in at least one objective. Those solutions which are not dominated by any of the other solutions in light of all of the objectives are referred to as a Pareto-optimal solutions through Pareto optimization, i.e., Pareto-optimal solutions are non-dominated solutions and no other solution dominates them. The set of outcomes (objective values) obtained from all of the Pareto-optimal solutions defines a Pareto-front, sometimes referred to as a Pareto-frontier. This Pareto-front may be shown graphically to analyze the objective values. Some known multi-objective optimization ML systems use a Pareto-optimal analysis, however, such systems do not search over ML pipelines as described herein, that is, they do not include both data transformers and model when searching. Moreover, such known Pareto-based multi-objective optimization ML systems that ignore transformers may demonstrate difficulty in estimating a good Pareto-front within established computing budgets, temporal budgets, and with the desired number of points on the Pareto-front. Moreover, many known multi-objective optimization ML systems cannot execute optimization operations on opaque, i.e., “black box” objectives that may be user-generated, since the details of the operations and functions therein are typically not visible.

A system and method are disclosed and described herein directed toward performing multi-objective automated machine learning to optimize a plurality of objectives. In one or more embodiments, data intended to be used as input to a machine learning (ML) model for solving problems, resolving queries presented to them is input to a multi-objective joint optimization system. In addition, a set of objectives to be attained, i.e., objectives of interest, are input into the multi-objective joint optimization system. Typically, the objectives will be to either minimize or maximize the respective outcomes. In some embodiments, custom objectives such as robustness and fairness measures of a result are used. Also, in some embodiments, domain-specific custom objectives may be used.

Moreover, in some embodiments, one or more black box objectives may be used. In general, a transparent objective, i.e., “white box” objective is an objective where the functional or analytical form of the objective function f(x) is known. For example, if a function is defined requiring a 2-dimensional input vector similar to F(x₁, x₂)=[x₁²+sqrt(x₂)], then the functional form of this function is known. However, for black box objectives, such functional formulations are not known. This is typical in instances of ML problems where the objective functions f(x) do not have any functional form. In such instances, the model is initially trained on some training dataset, then the objective function f(x) is evaluated, e.g., and without limitation, classification accuracy, by making predictions using the model and then determining the accuracy. In some cases, a user may define and provide a black box objective function f(x) where only the inputs are injected and the output values are obtained without concern about the implementation of the user-provided objective function f(x). In addition, in some cases, a user may define and provide “closed-form” objective functions f(x), where such expressions are configured to solve a given problem in terms of a finite number of standard functions and operations, e.g., including simple arithmetic, trigonometric, logarithmic, etc. functions. Therefore, some optimization systems may support only black-box objectives, some systems may support only closed-form objectives, and some systems may support both objectives. Accordingly, the optimization systems described herein may be configured to process any inputted objectives that enable operation of the multi-objective joint optimization system as described herein.

In addition, one or more standard evaluation metrics may be used as objectives, such as, and without limitation, accuracy, precision, recall, false positive rate (FPR), Matthews correlation coefficient (MCC), and area under receiver operating characteristics curve (AUROC).

In at least one embodiment, the one or more ML pipeline search spaces are built. The ML pipeline search spaces include a plurality of components that will be used to define a plurality of ML pipelines as described further herein. The components include a plurality of data transformers, one or more ML models along with their associated hyperparameters that will be sequentially arranged to define the respective ML pipelines.

In one or more embodiments, a determination is made as to whether optional inputs are provided for using a single objective optimizer (discussed further herein) or a particular user-specified machine learning pipeline. If there are no optional inputs, a scheme for performing multi-objective Combined Algorithm Selection and Hyperparameter (CASH) optimization over the entire pipeline search space is executed with respect to one or more algorithms and the associated hyperparameters. The multi-objective CASH optimization returns a set of ML pipelines as Pareto-optimal solutions optimizing multiple objectives of interest. In general, an ML pipeline can consist of multiple sequential stages. Without loss of generality, ML pipelines having three sequential stages may be considered; however, any number of sequential stages that enables operation of multi-objective CASH optimization as described herein may be used. The first stage is a preprocessing stage that backfills, handles categorical values, scales the feature values of the input dataset through one or more algorithms, where each algorithm has a respective set of hyperparameters. The scaled features are transmitted to a second stage, i.e., a features engineering stage that is configured to combine, remove, and add features through one or more algorithms, where each algorithm has a respective set of hyperparameters, and the algorithms and hyperparameters are different from those in the preprocessing stage. The engineered features are transmitted to a modeling stage that is configured to train machine learning model through one or more algorithms, where each algorithm has a respective set of hyperparameters, and the algorithms and hyperparameters are different from those in the preprocessing and feature engineering stages.

In some embodiments, the optional inputs, i.e., a user-specified ML pipeline or single objective optimizer inputs are not provided. In such cases a scheme for performing multi-objective CASH optimization is used. The set of objectives and the data from the pipeline search space (e.g., and without limitation, pipeline steps, transformers, and models) are translated into a conditionally constrained multi-objective optimization problem with discrete and continuous variables representing choices for algorithm parameters and hyperparameters. This problem is reformulated (using barrier smoothing) into a nonlinear optimization problem (possibly convex) in continuous variables and linear constraints (thereby replacing the conditional constraints). The reformulated problem is translated into an unconstrained Multi-Objective Optimization (MOO) problem through non-linear or convex formulation and smoothening functions like log barrier functions via penalty or Lagrangian relaxations. The unconstrained MOO problem can be solved using Multi Objective Bayesian Optimization schemes, such as, and without limitation, Uncertainty-Aware Search Framework for Multi-Objective Bayesian Optimization (USeMO), Max-value Entropy Search for Multi-objective Optimization (MESMO), and the like, or GA based schemes, such as, and without limitation, Non-dominated Sorting Genetic Algorithm (NSGA-II). The data in injected into this process and a set of pipelines are presented as Pareto-optimal solutions.

In some embodiments the optional input, i.e., a user-specified ML pipeline or single objective optimizer inputs have been provided. In such cases a scheme including a combination of single objective CASH optimization and pipeline refinement is employed. The single objective CASH optimization takes an objective to be optimized as user input (e.g., one of the objectives to be optimized) on the single objective optimizer and employs that optimizer to determine the pipeline steps of the full ML pipeline. Subsequently, the pipeline refinement scheme takes either the pipeline steps provided by the user or outputted by the single objective CASH optimization in the form of an ML pipeline with the inputted objective optimized and modifies the pipeline. A first pipeline refinement option is to use any multi-objective optimization (MOO) scheme on the model/estimator in the pipeline to refine the hyperparameters of the model to optimize all the objectives in the multi-objective optimization problem. A second option is to use any MOO scheme to refine the entire pipeline, including the preprocessing stage, feature engineering stage, and modeling hyperparameters to optimize all the objectives. A resultant set of pipelines are obtained as Pareto-optimal solutions. Accordingly, a single objective CASH optimization results in one or more single objective ML pipelines that are refined through using all of the objectives, i.e., undergo pipeline refinement to provide the best results for all of the objectives, or in some embodiments, the best tradeoff between the multiple objectives.

The resultant set of pipelines are presented as Pareto-optimal solutions in the form of a generated Pareto-front. The Pareto-front includes the vectors of the plurality of objective values F(x), i.e., the optimized numerical values associated with each point on the Pareto-front resulting from optimizing the respective aggregated single objective. For example, for the set of x, i.e., {x¹, x², . . . x^{k}} that denotes the set of Pareto-optimal solutions, then the Pareto-front includes the set of objective values on these Pareto-optimal solutions. As such, the Pareto-front will be defined by the set of {F(x¹), F(x²), . . . F(x^{k})}, where each objective value F(x) is a vector of objectives that need to be optimized (i.e., maximized or minimized). For example, in the instance of the bi-objective problem, each objective value F(x) is a vector [f₁(x), f₂(x)], and the points can be plotted as a two-dimensional graph representing the Pareto-front. Therefore, as used herein, the objective value refers to those values of F(x) of the Pareto-optimal solutions.

In one or more embodiments, the Pareto-front curve is generated and provided to the user through a graphical user interface for the user's inspection and selection. The user will select the solution that provides the desired objective values. The associated ML pipelines will be identified based on the selected solution.

In one or more embodiments, a multi-objective CASH optimization process is executed to define the multi-objective optimization problem with the respective constraints and discrete variables. The process reformulates constraints (e.g., without limitation, coupled constraints and conditional constraints) and the discrete variables such that a complete formulation transformation is performed to redefine the multi-objective optimization problem with relaxed constraints and continuous variables. The redefined problem is executed through unconstrained and continuous multi-objective optimization to generate a Pareto-front curve, thereby providing to the user, through a graphical user interface, for the user's inspection and selection, the plurality of solutions so that the user may select the solution that provides the desired objective values, or at least, solutions that provide acceptable tradeoffs between the objectives

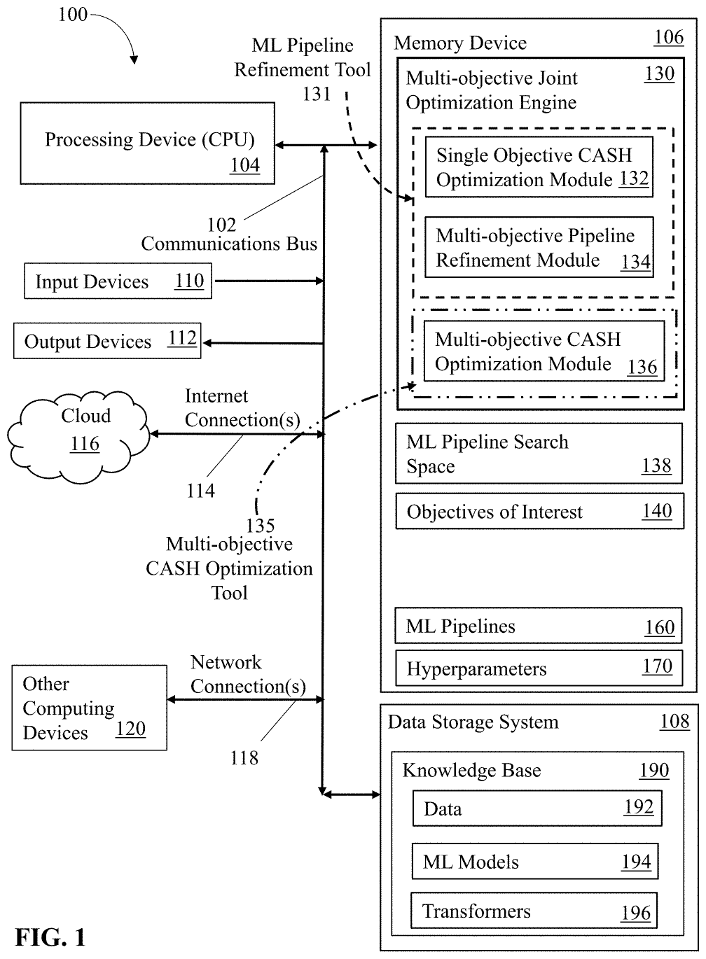

Referring to FIG. 1, a block schematic diagram is presented illustrating a computer system, i.e., a multi-objective automated machine learning system 100 (herein referred to as “the MOAML system 100”) that is configured for performing multi-objective automated machine learning, and, more specifically, to execute the multi-objective automated machine learning over an entire machine learning pipeline for a dataset and multiple objectives of interest, in accordance with some embodiments of the present disclosure. The MOAML system 100 includes one or more processing devices 104 (only one shown) communicatively and operably coupled to one or more memory devices 106 (only one shown) through a communications bus 102, and in some embodiments, through a memory bus (not shown). In some embodiments, the processing device 104 is a multicore processing device. The MOAML system 100 also includes a data storage system 108 that is communicatively coupled to the processing device 104 and memory device 106 through the communications bus 102. In at least some embodiments, the data storage system 108 provides storage to, and without limitation, a knowledge base 190 that includes at least a portion of the data and software artifacts to enable operation of the MOAML system 100 as described further herein.

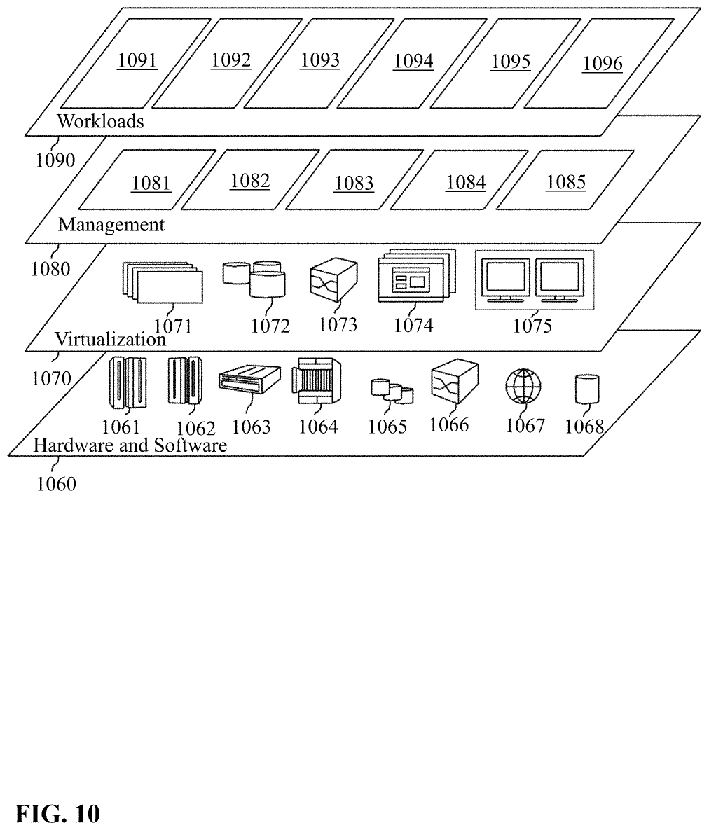

The system 100 further includes one or more input devices 110 and one or more output devices 112 communicatively coupled to the communications bus 102. In addition, the system 100 includes one or more Internet connections 114 (only one shown) communicatively coupled to the cloud 116 through the communications bus 102, and one or more network connections 118 (only one shown) communicatively coupled to one or more other computing devices 120 through the communications bus 102. In some embodiments, the Internet connections 114 facilitate communication between the system 100 and one or more cloud-based centralized systems and/or services (not shown in FIG. 1). In at least some embodiments, the MOAML system 100 is a portion of a cloud computing environment (see FIG. 10), e.g., and without limitation, the MOAML system 100 is a computer system/server that may be used as a portion of a cloud-based systems and communications environment through the cloud 116 and the Internet connections 114.

In one or more embodiments, a multi-objective joint optimization engine 130 (herein referred to “the engine 130”) is resident within the memory device 106. The engine 130 is discussed in detail further in this disclosure. The engine 130 is configured to facilitate performing multi-objective automated machine learning, and, more specifically, to execute the multi-objective automated machine learning over an entire machine learning pipeline for a dataset and multiple objectives. In at least some embodiments, the engine 130 resident in the memory device 106 is configured to run continuously in the background to automatically execute the multi-objective automated machine learning over the entire machine learning pipeline. In some embodiments, the engine 130 is engaged for specific tasking by the users thereof.

In at least some embodiments, the engine 130 includes a single objective combined algorithm selection and hyperparameter (CASH) optimization module 132, a multi-objective pipeline refinement module 134, and a multi-objective CASH optimization module 136, each of which is discussed in more detail herein. The engine 130 also includes, in some embodiments, a ML pipeline search space 138 that is built through being populated with the textual names of at least a portion of the one or more ML models 194 and transformers 196 (resident within the knowledge base 190) that can be used for creating a plurality of ML pipelines 160. The engine 130 further includes, in some embodiments, a set of objectives of interest 140 that are configured as potential input into the engine 130 to, without limitation, facilitate minimizing or maximizing the respective outcomes. In some embodiments, the set of objectives of interest 140 include custom objectives such as robustness and fairness measures of a result, closed-form objectives, domain-specific custom objectives, opaque or black box objectives, and in contrast to the black box objectives, transparent, i.e., white box objectives.

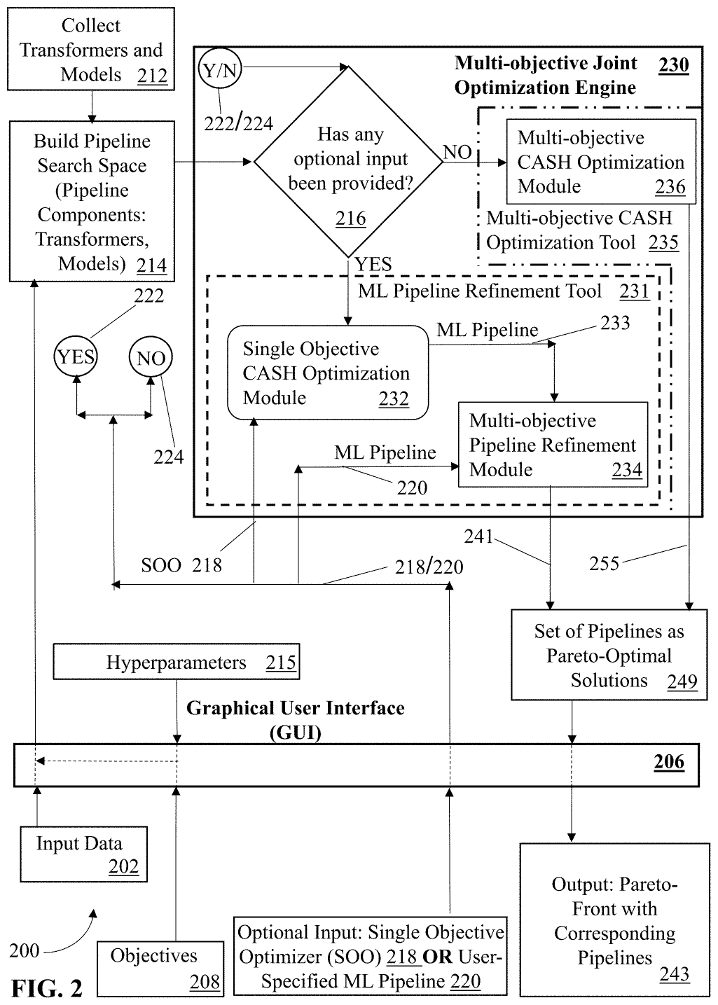

In addition, as mentioned above, in some embodiments, the engine 130 includes a plurality of ML pipelines 160 that are configured with. i.e., defined through, components that include, without limitation, at least a portion of the ML models 194 and transformers 196 resident within the knowledge base 190. For example, and without limitation, the ML models 194 and transformers 196 are a pre-defined collection (library) of known transformers 196 and ML models 194 that can be used for solving multi-objective optimization problems and populating the ML pipeline search space 138 using at least a portion, or subset, of the ML models 194 and transformers 196. Furthermore, in some embodiments, in addition to the previously described ML pipeline components, the ML pipelines 160 include a plurality of user-selected hyperparameters 170 to further define the respective ML pipelines 160. The engine 130 is discussed in detail further in this disclosure. In some embodiments, at least a portion of the data 192 is intended to be used as input to the one or more ML models 194, i.e., ingested by the multi-objective joint optimization engine 130. Accordingly, the remainder of the items in the memory device 106 and the data storage system 108 are discussed further with respect to FIGS. 2-7B.

Referring to FIG. 2, a flowchart is presented illustrating a process 200 for performing multi-objective automated machine learning to optimize a plurality of objectives. Also referring to FIG. 1, in one or more embodiments, input data 202 (at least a portion of the data 192 in FIG. 1 includes the input data 202) intended to be used as input to one or more machine learning (ML) models 194 (resident in the knowledge base 190) is input to, i.e., ingested by the multi-objective joint optimization engine 230 (shown as 130 in FIG. 1), through the GUI 206. The input data 202 is used for solving problems, resolving queries presented to them, or generating predictions of particular outcomes. The multi-objective joint optimization engine 230 is referred to herein as the engine 230, and is discussed in detail further in this disclosure. In one embodiment, the data 202 is input into the engine 230 as a portion of the data 192 from the knowledge base 190 resident in the data storage system 108. In some embodiments, the data 202 in input into the engine 230 through one or more of the input devices 110, such as, and without limitation, a graphical user interface, or GUI 206.

In addition, in some embodiments, a set of objectives 208 to be optimized, sometimes referred to as objectives 208 of interest (shown as 140 in FIG. 1), are input into the engine 230 through the GUI 206. Typically, the outcome of the objectives 208 will either need to be minimized or maximized. In some embodiments, custom objectives such as robustness and fairness measures of a result are used. Also, in some embodiments, domain-specific custom objectives may be used. Moreover, in some embodiments, one or more black box objectives or closed-form objectives may be used. In general, in contrast to black box objectives, a transparent, i.e., white box objective is an objective where the functional or analytical form of the objective function f(x) is known. For example, if a function is defined requiring a 2-dimensional input vector similar to F((x₁, x₂))=[x₁²+sqrt(x₂)], then the functional form of this function is known. However, for black box objectives, such functional formulations are not known. This is typical in instances of ML problems where the objective functions f(x) do not have any functional form with respect to the inputs. In such instances, the respective ML model 194 is initially trained on some training dataset, then the objective function f(x) is evaluated, e.g., and without limitation, classification accuracy, by making predictions using the ML model 194 and then determining the accuracy. In some cases, a user may define and provide a black box objective function f(x) where only the inputs are injected and the output values are obtained without concern about the implementation of the user-provided objective function f(x). Accordingly, any inputted objectives 208 that enable operation of the MOAML system 100 as described herein are used.

In one or more embodiments, one or more data transformers and ML models are collected 212 (where the ML models and the transformers are labeled 194 and 196, respectively, in FIG. 1, both resident in the knowledge base 190) and a ML pipeline search space 138 (resident in the memory device 106) is built 214 through populating the ML pipeline search space 138 with the textual names of the ML models 194 and transformers 196 that can be used for creating a plurality of ML pipelines 160 (resident in the memory 106). The ML models 194 and transformers 196 are components that will be selected to define the plurality of ML pipelines 160. Specifically, in some embodiments, the collection step 212 includes choosing a subset of the ML models 194 and transformers 196 from a pre-defined collection (library) of known transformers and models that can be used for multi-objective optimization problem and the building operation 214 is configured to populate the ML pipeline search space 138 using the ML models 194 and transformers 196 from this subset. In addition, ML pipeline components include a plurality of user-selected hyperparameters 215 (shown as 170 in FIG. 1) to further define the respective ML pipelines 160. The user-selected hyperparameters 215 are input through the GUI 206. Moreover, in some embodiments, one or more standard evaluation metrics may be used as objectives 208, including, without limitation, accuracy, precision, recall, false positive rate (FPR), Matthews correlation coefficient (MCC), and area under receiver operating characteristics curve (AUROC).

Continuing to refer to FIG. 2, a determination step 216 is executed to determine if any optional inputs have been provided by the user. Such optional inputs include, without limitation, a single objective optimizer 218 or a user-specified ML pipeline 220, where the user-specified ML pipeline 220 may be selected from the ML pipelines 160. The single objective optimizer 218 and the user-specified ML pipeline 220 are discussed further herein. One of the single objective optimizer 218 and the user-specified ML pipeline 220 are employed by the user through the GUI 206 to define the ML pipeline 160 that will be used for further refinement. A “YES” determination is the result of the determination step 216 when the user elects to use one of the single objective optimizer 218 and the user-specified ML pipeline 220. For such a decision by the user, one of the single objective optimizer 218 and the user-specified ML pipeline 220 is transmitted to a ML pipeline refinement tool 231 (shown as ML pipeline refinement tool 131 in FIG. 1) and a “YES” signal 222 or a “NO” signal 224 is transmitted to the determination step 216, where the “YES” signal 222 will facilitate selection of the ML pipeline refinement tool 231 and the “NO” signal 224 will facilitate selection of a multi-objective Combined Algorithm Selection and Hyperparameter (CASH) optimization tool 235 (shown as multi-objective CASH tool 135 in FIG. 1), also described further herein. Accordingly, if the determination of the determination step 216 is “YES”, the process 200 proceeds to a ML pipeline refinement tool 231 that is discussed further herein.

In one or more embodiments, the ML pipeline refinement tool 231 includes a single objective CASH optimization module 232 (shown as single objective CASH optimization module 132 in FIG. 1) and a multi-objective pipeline refinement module 234 (shown as multi-objective pipeline refinement module 134 in FIG. 1), where the modules 232 and 234 are communicatively and operably coupled to each other in the ML pipeline refinement tool 231.

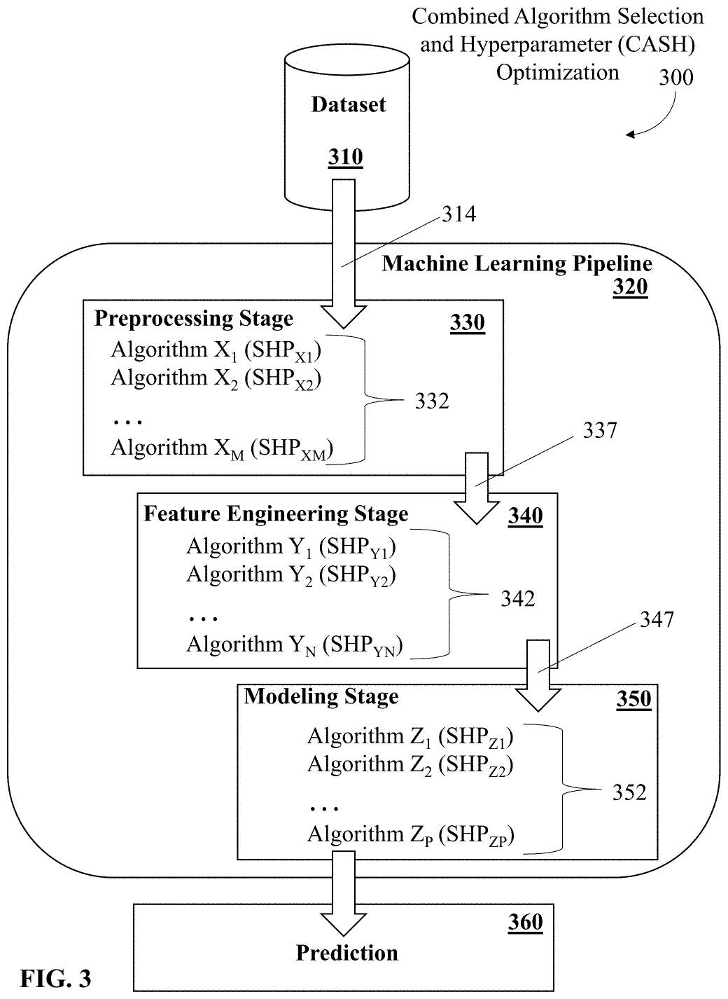

Referring to FIG. 3, a block schematic diagram is presented illustrating a Combined Algorithm Selection and Hyperparameter (CASH) optimization process 300, in accordance with some embodiments of the present disclosure. The more generalized CASH optimization process 300 shares many features and characteristics of the single objective CASH optimization module 232 and a multi-objective CASH optimization module 236 (shown as multi-objective CASH optimization module 136 in FIG. 1), where the CASH optimization modules 232 and 236 are distinguished from each other further herein. As the title of the CASH optimization process 300 suggests, the CASH optimization modules 232 and 236 are configured to optimize a collection of algorithms and hyperparameters over the ML pipeline search space 138. Each CASH optimization process 300 includes a dataset 310 that is input to a ML pipeline 320 that generates a prediction 360 as an output as a function of the processed data.

Each ML pipeline 320 includes multiple stages. In some embodiments, there are three stages, including an initial preprocessing stage 330 communicatively and operably coupled to the dataset 310. The ML pipeline 320 also includes a feature engineering stage 340 communicatively and operably coupled to the preprocessing stage 330. The ML pipeline 320 further includes a modeling stage 350 communicatively and operably coupled to the feature engineering stage 340, where the prediction 360 is output from the modeling stage 350. In some embodiments, the ML pipeline 320 includes any number of stages configured for any domain of operations that enables operation of the engine 130, the process 200, and the CASH optimization process 300 as described herein. In some embodiments, each stage 330, 340, and 350 of the ML pipeline 320 includes multiple choices for algorithms that may be used for that particular stage in the ML pipeline 320. Each of these algorithms has a corresponding set of hyperparameters (SHP) resident in that particular algorithm's hyperparameter search space. Accordingly, the CASH optimization process 300 is configured to employ a plurality of stages, each stage with a plurality of user-selected algorithms and hyperparameters that are analyzed and selected through each stage as optimized algorithms and hyperparameters, where the three sets of optimized algorithms and hyperparameters provide an optimized (such as, e.g., highest accuracy) prediction.

In one or more embodiments, a generalized combined algorithm selection and hyperparameter (CASH) optimization algorithm is used to select the algorithms for further processing in each of the preprocessing stage 330, the feature engineering stage 340, and the modeling stage 350. The following equation is configured to show the CASH optimization for a single stage pipeline:

A*_{λ*}∈argmin [symbol] (A_{λ}^{(j)},Dᵢₙₚᵤₜ, (Equation 3)

where (1) A*_{λ*} represents the one or more algorithms selected from a set of algorithms represented as [symbol] ={A⁽¹⁾, A⁽²⁾, . . . , A^{(k)}}, the “*” representing the “one or more” aspect, the variable k representing the number of respective algorithms in the set of algorithms A from which the selected one or more A*_{λ*} are selected, and λ* represents the one or more hyperparameters λ associated with the one or more hyperparameter spaces Λ¹, Λ², . . . , Λ^{k}; (2) the selected one or more algorithms A*_{λ*} are elements of the resultant smallest possible values for user-provided objective(s) that need to be minimized through the “∈ argmin” expression over A^{(j)} ∈A, λ∈Λ; (3) the [symbol] expression represents the user-provided objective(s) that need to be minimized; (4) the domains for the [symbol] expression include the algorithm from [symbol] , along with its associated hyperparameter set, and input data Dᵢₙₚᵤₜ. An extension of this CASH optimization that is configured for a multi-objective pipeline is discussed further in this disclosure.

In at least some embodiments, the preprocessing stage 330 is configured to ingest the dataset 310 and execute one or more predetermined operations on the data 314 in the dataset 310 in preparation for injection of preprocessed data 337 into the feature engineering stage 330 (as described further herein). For example, and without limitation, examples of preprocessing operations include backfilling missing values, converting non-numerical categorical characteristic values into numerical values, and normalizing or scaling the numerical values of certain characteristics between some minimum value and/or some maximum value. The preprocessing stage 330 includes a library of preprocessing algorithms 332 with each algorithm having a corresponding set of hyperparameters, i.e., a first algorithm X₁ with a corresponding first set of respective hyperparameters SHP_{X1}. There are a total of M algorithms 332, where M is any integer that enables operation of the CASH optimization process 300 as described herein. Accordingly, the preprocessing stage 330 is configured to select the optimized combination of a single algorithm and its corresponding hyperparameters from the set of M algorithms 332 to generate the highest accuracy prediction, or predictions 360.

Referring to Equation 3 above, the library of preprocessing algorithms 332 is substantially equivalent to the set of algorithms represented generally as [symbol] ; Algorithm X₁ (SHP_{X1}), Algorithm X₂ (SHP_{X2}), . . . , Algorithm X_{M} (SHP_{XM}) are substantially equivalent to A_{λ}^{(j)}, i.e., X_{SHPX}¹, X_{SHPX}², . . . , X_{SHPXM}^{M}, where M is substantially equivalent to k in Equation 3; and the sets of respective hyperparameters SHP_{X1}, SHP_{X2}, . . . , SHP_{XM} are substantially equivalent to a set of one or more hyperparameters λ associated with the one or more hyperparameter spaces Λ¹, Λ², . . . , Λ^{k}.

As non-limiting examples, algorithms that can be used to facilitate the preprocessing activities executed in the ML pipeline 320, and more specifically, the preprocessing stage 330 as one of the algorithms X₁ through X_{M} in the library of preprocessing algorithms 332, include imputation for handling missing values in data, encoding for handling categorical features in data, data scaling, normalization, and binning. In some embodiments, any algorithms that enable operation of the preprocessing stage 330 as described herein are used.

Therefore, in some embodiments, for example, and without limitation, the injected data 314 from the dataset 310 into the preprocessing stage 330 includes missing values and the selected preprocessing algorithm (and the associated hyperparameters), i.e., an imputation algorithm, is configured to backfill the missing values. Accordingly, the preprocessed data 337 that is to be injected into the feature engineering stage 340 includes the previously missing data values, i.e., substantially all the missing data values have been backfilled through the preprocessing stage 330.

In one or more embodiments, the feature engineering stage 340 is configured to receive the preprocessed data 337 from the preprocessing stage 330 and maintain, remove, or create features to facilitate the operation of the modeling stage 350 in generating the prediction 360. For example, certain features may be of a low priority, or even inconsequential with respect to the information that provide, and the user does not want to expend computing resources on such features. Also, for example, certain features may be missing from the preprocessed data 337 and the user deems such features necessary for generating the prediction 360. Such new features may include transformed features or combinations of features. In some embodiments, the features include, without limitation, principal component analyses and detection algorithms. The feature engineering stage 340 includes a library of feature engineering algorithms 342 and associated hyperparameters, i.e., a first algorithm Y₁ with corresponding hyperparameters SHP_{Y1}. There are a total of N algorithms 342, where N is any integer that enables operation of the CASH optimization process 300 as described herein. Accordingly, the feature engineering stage 340 is configured to select the optimized combination of a single algorithm and its corresponding hyperparameters from the set of N algorithms 342 to generate the highest accuracy prediction 360 through transmission of the combination 347 of the preprocessed data 337 and the selected engineered features.

Again, referring to Equation 3 above, the library of feature engineering algorithms 342 is substantially equivalent to the set of algorithms generally represented as [symbol] ; Algorithm Y₁ (SHP_{Y1}), Algorithm Y₂ (SHP_{Y2}), . . . , Algorithm Y_{N} (SHP_{YN}) are substantially equivalent to A_{λ}^{(j)}, i.e., Y_{SHPY1}¹, Y_{SHPY2}², . . . , Y_{SHPYN}^{N}, where M is substantially equivalent to k in Equation 3; and the sets of respective hyperparameters SHP_{Y1}, SHP_{Y2}, . . . , SHP_{YN} are substantially equivalent to a set of one or more hyperparameters λ associated with the one or more hyperparameter spaces Λ¹, Λ², . . . , Λ^{k}.

As non-limiting examples, algorithms that can be used to facilitate the feature engineering activities executed in the ML pipeline 320, and more specifically, the feature engineering stage 340 as one of the algorithms Y₁ through Y_{N} in the library of feature engineering algorithms 342, include principal component analysis, random projection, variance thresholding, and high correlation filtering. In some embodiments, any feature engineering algorithms that enable operation of the feature engineering stage 340 as described herein are used.

Therefore, in some embodiments, for example, and without limitation, the preprocessed data 337 with the backfilled missing data values and the selected features define a combination 347 thereof that is to be injected into the modeling stage 350.

In some embodiments, the combination 347 of the preprocessed data 337 and the engineered features are injected into the modeling stage 350 and the one or models therein generate the prediction 360. The modeling stage 350 includes a library of modeling algorithms 352 and corresponding hyperparameters, i.e., a first algorithm Z₁ that is a function of a first set of respective hyperparameters SHP_{Z1}. There are a total of P algorithms 352, where P is any integer that enables operation of the CASH optimization process 300 as described herein. Accordingly, the modeling stage 350 is configured to select the optimized combination of algorithms and hyperparameters 352 to generate the highest accuracy prediction 360.

Once again, referring to Equation 3 above, the library of modeling algorithms 352 is substantially equivalent to the set of algorithms generally represented as [symbol] ; Algorithm Z₁ (SHP_{Z1}), Algorithm Z₂ (SHP_{Z2}), . . . , Algorithm Z_{P} (SHP_{ZP}) are substantially equivalent to A_{λ}^{(j)}, i.e., Z_{SHPZ1}¹, Z_{SHPZ2}², Z_{SHPZP}^{P}, where P is substantially equivalent to k in Equation 3; and the sets of respective hyperparameters SHP_{Z1}, SHP_{Z2}, . . . , SHP_{ZP} are substantially equivalent to a set of one or more hyperparameters λ associated with the one or more hyperparameter spaces Λ¹, Λ², . . . , Λ^{k}.

As a non-limiting example, XGBoost is one of the algorithms that can be used to facilitate the modeling activities executed in the ML pipeline 320, and more specifically, the modeling stage 350 as one of the algorithms Z₁ through Z_{P} in the library of modeling algorithms 352. In general, XGBoost (which stands for Extreme Gradient Boosting) is an open source, scalable, distributed gradient-boosted decision tree machine learning algorithm library that provides parallel tree boosting for regression, classification, and ranking problems. XGBoost has multiple hyperparameters such as learning rate (float value between 0 and 1), maximum depth (positive integer value), and n-estimators (positive integer value) that may be set appropriately for good predictive performance. In some embodiments, other modeling algorithms that are employed include, without limitation, logistic regression, decision trees, Random Forests, k-nearest neighbors, and gradient boosting.

In some embodiments, the determinations of the optimized algorithms and hyperparameters for each stage of the process 300 are executed substantially simultaneously in contrast to a serial, set of operations, to most rapidly determine the optimized sets of algorithms and hyperparameters. Accordingly, as discussed further herein, the single objective CASH optimization module 232 and the multi-objective pipeline refinement module 234 are configured to employ the plurality of stages (330, 340, 350), each stage with a plurality of algorithms and hyperparameters (332, 342, 352, respectively) that are analyzed and selected through each stage as optimized algorithms and hyperparameters, where the resulting three sets of optimized algorithms and hyperparameters provide an optimized (e.g., highest accuracy) prediction 360.

As another non-limiting example, one such user-selected single objective is determining classification error, i.e., the fraction of incorrect predictions. For such an objective, for the given input dataset 310, CASH optimization 300 over the ML pipeline 320 includes the process of selecting the algorithms and their corresponding hyperparameters for each respective stage 330. 340, and 350 of the ML pipeline 320 such that the predictions 360 from the ML pipeline 320 are optimized with respect to the given objective of classification error determinations. Given that the classification error is the objective that needs to be minimized in this example, the CASH optimization process 300 includes choosing an algorithm and its corresponding set of hyperparameters (SHP) for each of the 3 stages 330, 340, and 350 of the ML pipeline 330 that provides the least value of classification error. The chosen algorithms and hyperparameters, in this example, will describe the best pipeline obtained by the CASH optimization process 300 from the ML pipeline search space 138 (see FIG. 1). In some embodiments, the best pipeline selected to minimize classification error may look like Algorithm X₂ (SHP_{X2})>Algorithm Y₁ (SHP_{Y1})>Algorithm Z_{P} (SHP_{ZP}) from the plurality of user-selected algorithms and hyperparameters 332, 342, and 352, respectively, that populate the respective stages 330, 340, and 350.

In some embodiments, the outputs of the ML pipeline 320 are one or more predictions 360 of which ML pipelines that represent the best ML pipelines for resolving one or more objectives, where each such output ML pipeline includes the respective algorithms (and their associated hyperparameters). These features are discussed further herein.

Therefore, in one or more embodiments, the CASH optimization process 300 is configured to execute single objective operations, such as, and without limitation, classification error. Moreover, in some embodiments, the CASH optimization process 300 is configured to execute multi-objective operations, such as, and without limitation, classification error and false positive rates for bi-objective optimization problems. Accordingly, the CASH optimization process 300 is discussed further herein with respect to both single optimization and multi-optimization problems.

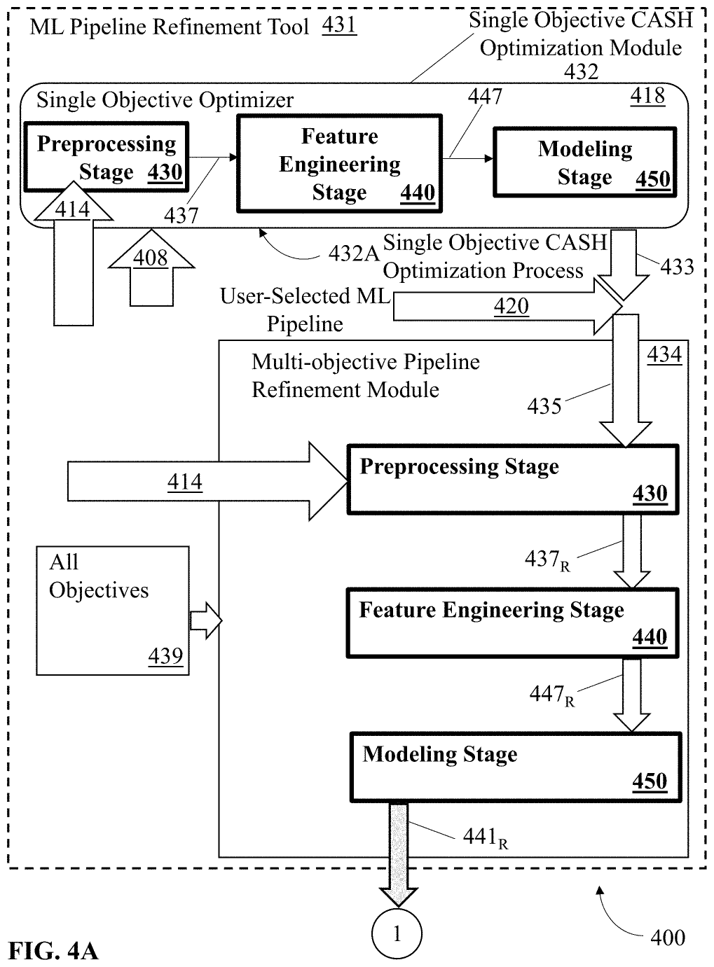

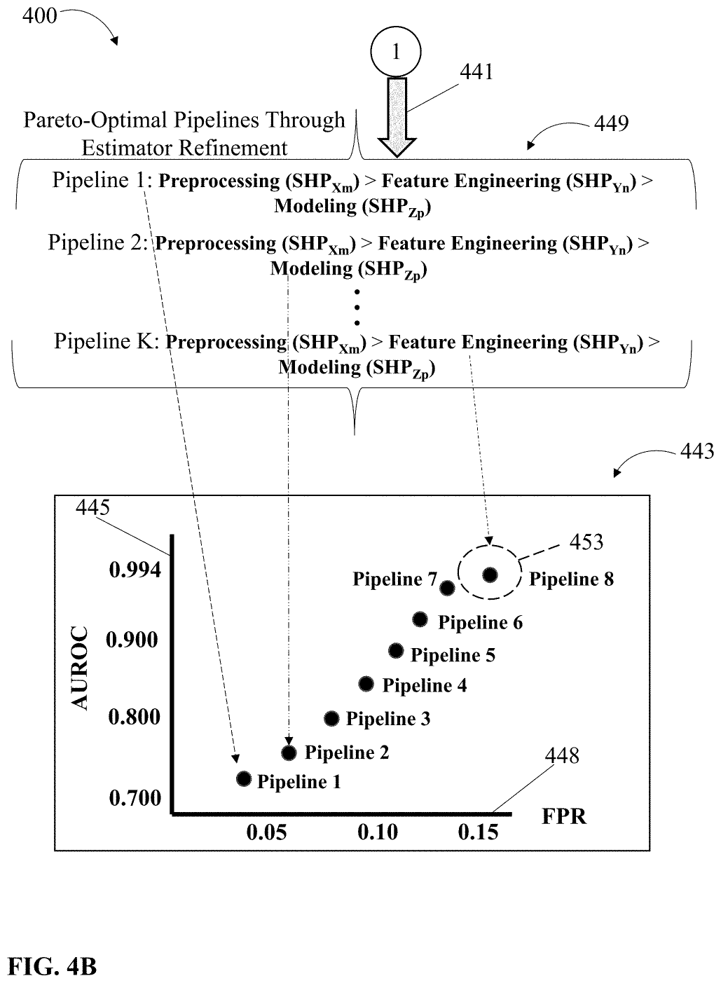

Referring again to FIG. 2, and continuing to refer to FIG. 3, prior to the execution of the CASH optimization process 300, the “YES” response from the determination step 216 is generated, thereby indicating that the user has injected an optional input of either the single objective optimizer 218 or the user-specified ML pipeline 220. Such a “YES” response results in the employment of the ML refinement tool 231. In some embodiments, as described with respect to FIG. 3, the single objective CASH optimization module 232 is used to generate a single objective optimized ML pipeline 233 for a user-specified single objective subject to one or more inputs (shown as data 314 in FIG. 3). In some embodiments, the user-specified single objective is transmitted through the single objective optimizer 218 as employed by the user via the GUI 206. In some embodiments, the user-specified single objective is transmitted through any mechanism that enables operation of the multi-objective joint optimization engine 130 as described herein. In some embodiments, the single objective optimizer 218 has a functional topology substantially similar to the machine learning pipeline 320, where the single objective optimizer 218 configured to generate a set of optimized pipeline components generated from the algorithms and associated hyperparameters 332, 342, and 352 that are selected from the ML pipeline search space 138. The single objective optimizer 218 is described further with respect to FIGS. 4A and 4B.

In some embodiments, the user-selected ML pipeline 220 is used, thereby bypassing the single objective CASH optimization module 232. Therefore, either one of the single objective optimized ML pipeline 233 or the user-selected ML pipeline 220 will be used (as discussed further herein) as input to the multi-objective pipeline refinement module 234. As such, the respective ML pipeline 220 or 233 is transmitted to the multi-objective pipeline refinement module 234 for refinement with one or more additional objectives (not shown in FIG. 2) to optimize all of the respective objectives. The multi-objective pipeline refinement module 234 is configured to generate one or more multi-objective optimized ML pipelines 241 for all the objectives that results in a set of pipelines as Pareto-optimal solutions 249 that are further transmitted through the GUI 206 to generate an output display of a Pareto-front with the corresponding pipelines 243 plotted thereon. The users are permitted to select the solution to the present multi-objective problem through selection of the pipeline from the set of pipelines 249.

Referring to FIG. 4A, a flowchart is presented illustrating a process 400 for multi-objective CASH optimization through the ML pipeline refinement tool 431 (shown as 131 and 231 in FIGS. 1 and 2, respectively), in accordance with some embodiments of the present disclosure. Also, continuing to refer to FIGS. 1, 2, and 3, the single objective CASH optimization module 432 is configured to receive the single objective optimizer 418 (shown as 218 in FIG. 2) from the user through the GUI 206. In some embodiments, the single objective optimizer 418 is transmitted with the single objective to be resolved embedded therein. In some embodiments, the single objective optimizer 418 and the single objective to be resolved are transmitted separately.

In one or more embodiments, the single objective optimizer 418 operates on the functional topology of the single objective CASH optimization module 432 that is substantially similar to the machine learning pipeline 320. Specifically, the injected single objective optimizer 418 (and single objective) are configured to execute a single objective CASH optimization process 432A that is substantially similar to the CASH optimization process 300. For example, the single objective CASH optimization module 432 includes the preprocessing stage 430, the feature engineering stage 440, and the modeling stage 450, that are substantially similar to the preprocessing stage 330, the feature engineering stage 340, and the modeling stage 350, respectively. Accordingly, in at least some embodiments, the single objective CASH optimization module 432 is operated on through the user-injected single objective optimizer 418 that is configured to execute the single objective CASH optimization process 432A.

In some embodiments, in a manner similar to the ML pipeline 320, each stage 430, 440, and 450 that is to be optimized by the user-injected single objective optimizer 418 includes multiple choices for algorithms that may be used for that particular stage in the single objective CASH optimization module 432. Each of these algorithms has a corresponding set of hyperparameters (SHP) resident in that particular algorithm's hyperparameter search space. Therefore, the single objective CASH optimization process 432A is configured to employ a plurality of stages, each stage with a plurality of user-selected algorithms and hyperparameters that are analyzed and selected through each stage as optimized algorithms and hyperparameters, where the three sets of optimized algorithms and hyperparameters provide one or more single objective optimized ML pipelines 433 (shown as 233 in FIG. 2) for a user-specified single objective.

In at least some embodiments, the single objective CASH optimization module 432 is configured to receive the injected data 414 (shown as 314 in FIG. 3) from one or more datasets 310 (shown in FIG. 3) through the preprocessing stage 430. In some embodiments, the data 414 for each optimization execution includes data that remains substantially static regardless of the domain and the number of objectives considered, where some of the data 414 may not be associated with the objectives, and some of the data may have some association with the objectives. As discussed further herein, the refinement uses the same data 414. Accordingly, preliminary data refinement for the objectives to be optimized is not necessary.

In some embodiments, in addition to the injected data 414, a single objective 408 that is one of the plurality of objectives 208 (see FIG. 2) to be resolved is provided as input into the single objective optimizer 418. For example, and without limitation, in some embodiments, there are a total of two objectives 208 to be optimized and the first single objective 408 is either the first or second objective of the two objectives 208. In some embodiments, the first single objective 408 to be optimized is not one of the objectives to be resolved, but may have a relationship with one or more of the plurality of objectives 208 to be resolved. In one embodiment, the primary objective to be resolved is the area under the receiver operating characteristics curve (AUROC) and the secondary objective to be resolved is the false positive rate (FPR). In some embodiments this selection is reversed. In some embodiments, more than two objectives are selected to be resolved, where the number of objectives is non-limiting. For example, and without limitation, the first single objective 408 to be optimized is the third objective of a total of five objectives 208 to be optimized. Accordingly, here, the AUROC is the user-selected first (primary) single objective to be resolved through the ML pipeline 433.

In at least some embodiments, the preprocessing stage 430 uses the data 314 to generate the preprocessed data 437 (as described for the preprocessed data 337). The preprocessed data 437 is transmitted to and processed by the feature engineering stage 440 to select the respective engineered features 447 (as described for the combination 347 including the engineering features) that are transmitted to the modeling stage 450. In one or more embodiments, the modeling stage 450 includes, as a non-limiting example, XGBoost as one or more of the algorithms that can be used to facilitate the modeling activities executed in the single objective CASH optimization process 432A. The modeling stage 450 generates the one or more single objective optimized ML pipelines 433 for transmission to a multi-objective pipeline refinement module 434, where the single objective 408 for which the ML pipeline 433 is generated is optimizing the AUROC.

In one or more embodiments, the multi-objective pipeline refinement module 434 has a functional topology substantially similar to the machine learning pipeline 320. The multi-objective pipeline refinement module 434 is configured to receive either the user-selected single objective ML pipeline 420 (labeled as 220 in FIG. 2) from the GUI 206 or the single objective optimized ML pipeline 433 from the single objective optimizer 418 and the single objective CASH optimization module 432. In some embodiments, one of the user-selected single objective ML pipeline 420 or the single objective optimized ML pipeline 433 is injected into the multi-objective pipeline refinement module 434 as ML pipeline 435. The multi-objective pipeline refinement module 434 is further configured to receive all of the objectives 439 (labeled as 208 in FIG. 2) simultaneously, and the data 414. Here, both the AUROC and FPR objectives are included in the all objectives 439 injection. The multi-objective pipeline refinement module 434 is configured to generate a prediction 441 of one or more multi-objective optimized ML pipelines for the objectives 439. The example discussed thus far includes the second objective of the FPR, where two objectives is non-limiting and any number of objectives that enables operation of the engine 130 as described herein may be executed.

In at least some embodiments, the preprocessing stage 430, the feature engineering stage 440, and the modeling stage 450 are replicated in the multi-objective pipeline refinement module 434. The refinement module 434 is configured to accept the injected objectives 439.

In some embodiments, the prediction 433 of the single objective optimized ML pipeline from the single objective optimizer 418 and the objectives 439 are transmitted to the preprocessing stage 430 resident within the multi-objective pipeline refinement module 434. In some embodiments, the user-selected ML pipeline 420 is transmitted to the preprocessing stage 430 in lieu of the prediction 433. Therefore, the MP pipeline 435 is introduced to the preprocessing stage 430. The preprocessing stage 430 includes the previously selected single algorithm (from the algorithms 332) that was used to generate the single objective ML pipeline prediction 433 optimizing the AUROC objective. The algorithm of the preprocessing stage 430 will remain unchanged; however, due to the injection of the objectives 439 (the AUROC and FPR objectives), the respective hyperparameters SHP_{X1} through SHP_{XM} (see FIG. 3) for both the first and second objectives will be further resolved to further “optimize” the two objectives together. The product of the preprocessing stage 430 is refined preprocessed data 437_{R} for the single objective (AUROC) refined for inclusion of the second objective (FPR).

Similarly, in some embodiments, the refined preprocessed data 437_{R} is transmitted to the feature engineering stage 440 resident within the multi-objective pipeline refinement module 434. The feature engineering stage 440 includes the previously selected single algorithm (from the algorithms 342) that was used to generate the single objective ML pipeline prediction 433 optimizing the AUROC objective. The algorithm of the feature engineering stage 440 will remain unchanged; however, due to the injection of the objectives 439 (the AUROC and FPR objectives), the respective hyperparameters SHP_{Y1} through SHP_{YN} (see FIG. 3) for both the first and second objectives have been further resolved to further “optimize” the two objectives together. The product of the feature engineering stage 440 is the refined engineered features 447_{R} for the single objective (AUROC) refined for the second objective (FPR).

In addition, in some embodiments, the refined engineered features 447_{R} are transmitted to the modeling stage 450 resident within the multi-objective pipeline refinement module 434. The modeling stage 450 includes the previously selected single algorithms (from the algorithms 352) that was used to generate the single objective ML pipeline prediction 433 optimizing the AUROC objective. The algorithm of the modeling stage 450 will remain unchanged; however, due to the injection of the objectives 439 (the AUROC and FPR objectives), the respective hyperparameters SHP_{Z1} through SHP_{ZP} (see FIG. 3) for both the first and second objectives have been further resolved to further “optimize” the two objectives together. The product of the modeling stage 450 is a plurality of revised multi-objective optimized ML pipeline predictions 441_{R} for the single objective (AUROC) refined for the second objective (FPR). Accordingly, the multi-objective pipeline refinement module 434 generates the plurality of multi-objective optimized ML pipeline predictions 441_{R} as discussed further herein. In some embodiments, the refinement module 434 uses multi-objective optimization methods such as, and without limitation, Uncertainty-Aware Search Framework for Multi-Objective Bayesian Optimization (USeMO), and Non-dominated Sorting Genetic Algorithm (NGSA II) for further resolving the hyperparameters for each of preprocessing stage 430, feature engineering stage 440, and modeling stage 450 to further “optimize” the two objectives together.

Referring to FIG. 4B, a continuation of the flowchart shown in FIG. 4A is presented further illustrating a graphical result 443 thereof, in accordance with some embodiments of the present disclosure. The graphical result 443 is similar to the output display of a Pareto-front with the corresponding pipelines 243. The first multi-objective optimized ML pipeline prediction 441_{R1} and the subsequent pipelines _{441Rβ}(β=2 through K) are Pareto-optimal solutions for the optimization problem, i.e., Pareto-optimal pipelines 449 established through estimator refinement that include both the AUROC and FPR objectives optimized. The graphical result 443 includes a Y-axis 445 that represents the AUROC objective values extending from approximately 0.700 to approximately 0.994. In general, the higher the value the better. The graphical result 443 also includes an X-axis 448 that represents the FPR objective values extending from approximately 0 to approximately 0.15. In general, the lower the value the better.

The predicted pipeline 1 (also referred to as the first multi-objective optimized ML pipeline prediction 441₁) of the Pareto-optimal pipelines 449 is shown in FIG. 4B as “Pipeline 1: Preprocessing (SHP_{Xm})>Feature Engineering (SHP_{Yn})>Modeling (SHP_{Zp}),” where “m” is the variable for 1 through M, “n” is the variable for 1 through N, and “p” is the variable for 1 through P. Each of the Pareto-optimal pipelines 449 may have any combination of the sets of hyperparameters for all of the stages that enables operation of the process 400 for multi-objective CASH optimization through the ML pipeline refinement tool 431. For example, for the present 2-objective example of AUROC and FPR as the objectives, each of m, n, and p can assume values from the set {1, 2, . . . , M}, {1, 2, . . . , N), and {1, 2, . . . , P}, respectively. Therefore, is some embodiments, the pipeline 1 will be “Preprocessing (SHP1_{X3})>Feature Engineering (SHP1_{Y1})>Modeling (SHP1_{Z2}),” the pipeline 2 will be “Preprocessing (SHP2_{X3})>Feature Engineering (SHP2_{Y1})>Modeling (SHP2_{Z2}),” where the two pipelines will differ in the values of the hyperparameters SHP_{X3} (denoted as SHP1_{X3} and SHP2_{X3}), SHP_{Y1} (denoted as SHP1_{Y1} and SHP2_{Y1}) and SHP_{Z2} (denoted as SHP1_{Z2} and SHP2_{Z2}).

In some embodiments, as a further example for pipeline 1, for the preprocessing stage 430, if SHP_{X3} denotes two hyperparameters, i.e., hyperparameters “a” and “b” (not shown), then SHP1_{X3}→a=5, b=3, where the hyperparameter “a” is 5 and the hyperparameter “b” is 3. Similarly, for example, SHP2_{X3}→a=1, b=10. As such, the pipeline 1 in this example will have values of hyperparameters as {a=5, b=3} and pipeline 2 will have {a=1, b=10}. SHP_{Y1} for the feature engineering stage 440 and SHP_{Z2} for the modeling stage 450 are treated similarly. The predicted pipeline 1 is plotted in the graphical result 443 with an “optimized” AUROC value of approximately 0.715 and an “optimized” FPR value of approximately 0.04.

Also, referring to FIG. 4A as well, in at least some embodiments, the preprocessing stage 430, the feature engineering stage 440, and the modeling stage 450 as shown in FIGS. 4A and 4B are bolded both as the individual blocks and the pipelines 449 (as “Preprocessing (SHP_{X1}) through Preprocessing (SHP_{Xm}),” “Feature Engineering (SHP_{Y1}) through Feature Engineering (SHP_{Yn}),” and “Modeling (SHP_{Z1})” through “Modeling (SHP_{Zp})”) to illustrate that the refinement of the output, i.e., the prediction 433 of the single objective optimizer 418 is executed across the entire ML pipeline 320 embedded within the multi-objective pipeline refinement module 434. As described above, the ML pipeline 435 is presented to the preprocessing stage 430; therefore, the user-selected ML pipeline 420 will be refined through similar mechanisms as described for the ML pipeline 433.

Continuing to refer to FIGS. 4A and 4B, as well as FIG. 3, in some embodiments, the multi-objective pipeline refinement module 434 generates the pipeline 2 of the Pareto-optimal pipelines 449 that includes a selected (optimized) algorithms 332, 342, and 352 associated with the preprocessing stage 430, the feature engineering stage 440, and the modeling stage 450, respectively, where the algorithms 332, 342, and 352 have been substantially unchanged since executing the single objective CASH optimization process 432A. The pipeline 2 of the Pareto-optimal pipelines 449 also includes the respective hyperparameters for the first and second objectives that have been further resolved to further “optimize” the two objectives together. In other words, the hyperparameters associated with the pipeline 2 will most likely be different from those hyperparameters for the pipeline 1; however, in some embodiments, the hyperparameters for one or more of the stages may not be changed. Therefore, the pipeline 2 of the Pareto-optimal pipelines 449 further includes the optimized algorithms (with the optimized hyperparameters) from the multi-objective pipeline refinement module 434. The pipeline 2 of the Pareto-optimal pipelines 449 is shown plotted in the graphical result 443 with an “optimized” AUROC value of approximately 0.750 and an “optimized” FPR value of approximately 0.06.

In at least some embodiments, the generation of the pipelines 1 through K is substantially simultaneous and the set of pipelines 1 through K are plotted simultaneously. In the illustrated example of the graphical result 443 the optimized pipelines 3 (not shown) through K of the Pareto-optimal pipelines 449 are shown plotted, where, in the present example, K=8. The pipelines 1 through 7 of the Pareto-optimal pipelines 449 are shown plotted in the graphical result 443 with improving optimization. The plotted point labeled 453 is the K^{th} (i.e., 8^{th}) plotted optimized result that, in the present example, represents the pipeline (Pipeline 8) with the optimized hyperparameters that provide the best results for AUROC but the worst value for FPR. For example, as described, the AUROC value is more beneficial as the value increases. Conversely, the FPR value is more beneficial as the value decreases. In the present example, both the AUROC and FPR values increase as the values 1 though K increase. The respective AUROC value is approximately 0.994, where AUROC is asymptotically approaching unity, and the FPR value is approximately 0.15 at the plotted point 453. In some embodiments, the user has specified a minimum tolerable value for AUROC and a maximum tolerable value for FPR. Therefore, in the present example, the process 400 for multi-objective CASH optimization through the ML pipeline refinement tool 431 results in a trade-off between the AUROC and FPR. In some embodiments, the user may select pipeline 1 if that particular user is hyper-sensitive to anything but the lowest values of FPR and is willing to trade-off greater values of AUROC. Accordingly, the process 400 for multi-objective CASH optimization through the ML pipeline refinement tool 431 is executed for those pipelines determined as a function of the single objective CASH optimization process 432A or the user-selected ML pipeline 420.

Once again, referring to FIG. 2, the determination step 216 is executed to determine if any optional inputs have been provided by the user. Such optional inputs include, without limitation, the single objective optimizer 218 or the user-specified ML pipeline 220, as discussed with respect to FIGS. 4A and 4B. A “NO” signal 224 is indicative of no optional inputs provided by the user. Therefore, the “NO” signal 224 is transmitted to the determination step 216, where the “NO” signal 224 will facilitate selection of the multi-objective CASH optimization tool 235 (shown as the multi-objective CASH tool 135 in FIG. 1). In one or more embodiments, the multi-objective CASH optimization tool 235 includes a multi-objective CASH optimization module 236 (shown as multi-objective CASH optimization module 136 in FIG. 1). The multi-objective CASH optimization module 236 is configured to generate one or more multi-objective optimized ML pipelines 255 for a plurality of objectives that result in a set of pipelines as the Pareto-optimal solutions 249 that are further transmitted through the GUI 206 to generate the output display of a Pareto-front with the corresponding pipelines 243 plotted thereon. The multi-objective CASH optimization module 236 is further configured to optimize a collection of algorithms and hyperparameters over the ML pipeline search space 138 in a manner similar to that described with respect to FIG. 3. The distinguishing characteristics of the multi-objective CASH optimization module 236 are discussed further herein. Accordingly, if the determination of the determination step 216 is “NO”, the process 200 proceeds to the multi-objective CASH optimization module 236 resident within the multi-objective CASH optimization tool 235.

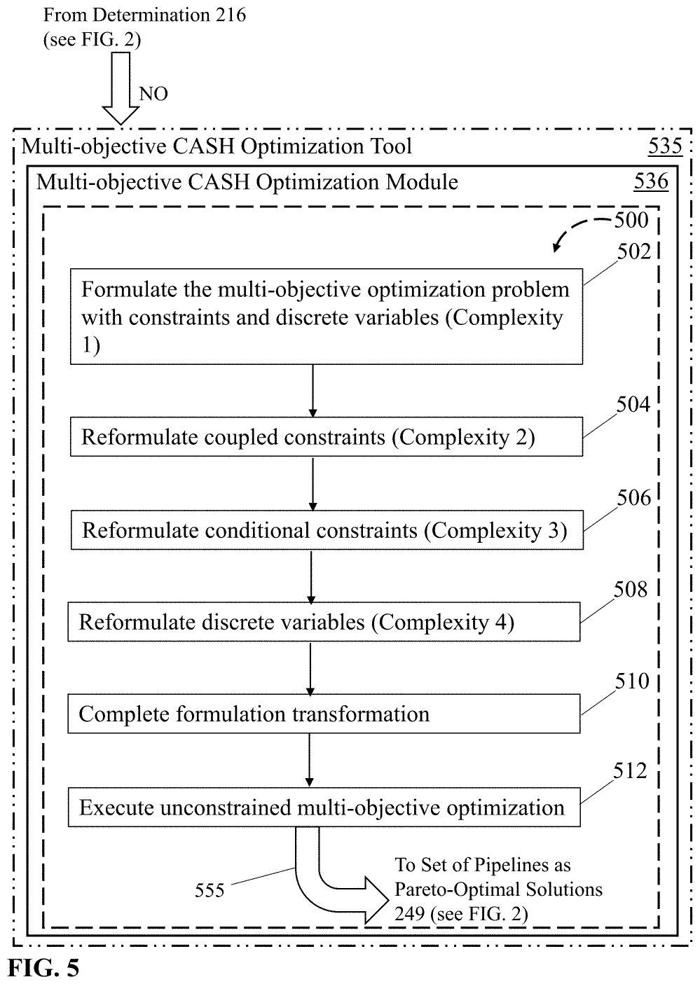

Referring to FIG. 5, a flowchart is presented illustrating a process 500 for multi-objective CASH optimization over an entire ML pipeline search space, in accordance with some embodiments of the present disclosure. The process 500 is executed through the multi-objective CASH optimization module 536 (shown as 236 in FIG. 2) that is resident in the multi-objective CASH optimization tool 535 (shown as 235 in FIG. 2). The execution of the process 500 is subject to receipt of the “NO” response from the determination 216 (see FIG. 2).

In some embodiments, the process 500 is configured to execute in a series of method steps, some of such method steps configured to address embedded computational complexities on a variety of levels to solve the more general multi-objective optimization problem of:

$${min}_{x , y , z , λ} F ( . ) = \{ {f}_{1} ( . ) , {f}_{2} ( . ) , … , {f}_{n} ( . ) \} , ( x , y , z , λ ) \qquad ( Equation 4 )$$

where the set of “f_{i(·)}” represents the continuous output functions that are to be minimized (or maximized), and “min F(·)” represents the optimization problem to be solved to provide the optimum tradeoff between the respective goals of minimizing each fᵢ(·) within the set of f₁(·) through fₙ(·). The optimization is to be executed over a set of values that include “x” that represents an integer in scalar form that defines the choice of the preprocessor index, “y” that represents an integer in scaler form that defines the choice of the feature engineering index, “z” that represents an integer in scaler form that defines the choice of the model, and “λ” that represents the respective one or more hyperparameters.

In at least some embodiments, the process 500 includes formulating, or defining, 502 the multi-objective optimization problem with constraints and discrete variables. Specifically, referring to equation 4 above, at least some known mechanisms to solve the multi-objective problem is to use a highly discrete single objective perspective. As discussed further below, equation 4 is formulated to execute based on discrete variables and multiple constraints. Also, many known multi-objective optimization methods use Bayesian optimization methods; however, such Bayesian optimization methods typically do not perform very well when the space of discrete variables is very large. As described further herein, Bayesian optimization of multi-objective problems is facilitated through reformulating the problem of equation 4 into a problem that uses continuous variables in an unconstrained manner. Accordingly, the expression of the multi-objective optimization problem in the form of equation 4 is referred to as the first computational complexity, i.e., complexity 1, where additional complexities are discussed further below.

In one or more embodiments, coupled constraints are used in conjunction with equation 4. For example, and without limitation, the hyperparameters may be coupled between the three stages of CASH optimization, i.e., the preprocessing stage 330, the feature engineering stage 340, and the modeling stage 350 (see FIG. 3), such that the problem statement of equation 4 does not facilitate independent processing through each of the three stages of the coupled hyperparameters. Therefore, the equation 4 may be subject to coupled constraints such as, and without limitation:

c(x,λ_{Z}),g(y,λ_{Z}),h(λₐ,λ_{Z})≤0, (Equation 5)

where c(x, λ_{Z}) represents the coupled constraint between the preprocessing stage 330 and the hyperparameters associated with the modeling stage 350, g(y, λ_{Z}) represents the coupled constraint between the feature engineering stage 340 and the hyperparameters associated with the modeling stage 350, and h(λₐ, λ_{Z}) represents a coupled constraint between a first hyperparameter λₐ of any of the stages and the hyperparameters associated with the modeling stage 350. The coupled constraints represent the second complexity, i.e., complexity 2. Constraints usually can be quite challenging and nonconvex, i.e., linear or concave, where linear and convex functions play an important role in the solutions of optimization problems. Specifically, the linear and convex functions are distinguished by a number of convenient properties, e.g., and without limitation, a strictly convex function on an open set has no more than one minimum value, thereby facilitating execution of the process 500. A linear function facilitates reducing the computing resources necessary for execution of the process 500.

In some embodiments, at least a portion of the coupled constraints are reformulated 604 as augmented Lagrangian formulations through one or more of associated penalties and relaxations of constraints. In some embodiments, at least a portion of the constraints are reformulated as linear constraints. i.e., non-linear constraints, such as, and without limitation, the generalized constraints of the form c(z, λ)≤0 are relaxed through either standard Lagrangian relaxation techniques or augmented Lagrangian techniques that adds an extra penalty term to the linearized constraints. For example, a nonlinear constraint may be reformulated as follows:

$$c ( z , λ ) \leq 0 ⟹ c ( z , λ ) + s ⟹ {min}_{x , c o nvex λ , s \geq 0} {η}^{*} ( c ( z , λ ) + s ) + ρ \vert \vert ( c ( z , λ ) + s ) {\vert \vert}^{2} , \qquad ( Equation 6 )$$

where “η” represents an optimal dual parameter, which, in some embodiments, is not required in practice, “s” denotes slack variables that are positive, and “ρ” represents a penalty coefficient value. The positive slack variables “s” are introduced artificially to transform the inequality constraints to equality constraints. In some embodiments, where only penalty methods are to be used to reformulate the coupled constraints through the augmented Lagrangian techniques, η*=0 is applied and ρ is set to a large numerical value.

In at least some embodiments, one strength of this reformulation is that when using gradient-based methods, the operations are executed in an element-wise manner, e.g., through variables such as “z”). Inherently, these operations break-down the processes into smaller processing events and can be parallelized, thereby increasing the efficiency of the respective processing tasks. Even in a serialized set of operations, standard Lagrangian relaxation techniques and augmented Lagrangian techniques for the discussed reformulation reduces the computational complexity significantly. Accordingly, an unconstrained version of the coupled constraints to the pipeline optimization problem between multiple levels is generated through the use of known standard Lagrangian and augmented Lagrangian techniques that include one or more of associated penalties and relaxations of constraints.

In one or more embodiments, “IF” constraints may be used in conjunction with equation 4. For example, and without limitation:

IF x=r,→λₓ=u₁, . . . ,else λₓ=u₁, (Equation 7)

IF y=s,→λₓ=v₁, . . . ,else λₓ=vₘ, and (Equation 8)

IF z=t,→λₓ=w₁, . . . ,else λₓ=wₙ, (Equation 9)

where u, v, and w, are all fixed constants and are set prior to solving the problem of equation 4. In addition, the uᵢ, vᵢ, and wᵢ are vectors for all “i” that are set accordingly. The three equations 7, 8, and 9 are conditional constraints. Equation 7 establishes that if the preprocessing stage is stage “r”, then the respective hyperparameter is u₁. Otherwise, if the preprocessing stage is not stage “r”, the hyperparameter for the preprocessing stage is “u₁”. Equation 8 establishes that if the feature engineering stage is stage “s”, then the hyperparameter for the preprocessing stage is v₁. Otherwise, if the feature engineering stage is not stage “r”, the hyperparameter for the preprocessing stage is “vₘ”. Equation 9 establishes that if the modeling stage is stage “t”, then the hyperparameter for the preprocessing stage is w₁. Otherwise, if the modeling stage is not stage “t”, the hyperparameter for the preprocessing stage is “wₙ”. The IF constraints represent the third complexity, i.e., complexity 3. Accordingly, the hyperparameters are related to the choices for the preprocessing, feature engineering, and modeling stages by means of IF statements. These conditional constraints, in addition to being nonconvex, are also discrete, where linear or convex and continuous constraints are desired to improve computational efficiency.

For at least some embodiments, the following example illustrates a mechanism to reformulate 506 IF constraints. i.e., relax the IF constraints. The example includes the IF constraint of:

IF x=0,y=0, and IF x=1,y=T, (Equation 10)

where T is a value of interest. To alleviate the IF constraint, additional scalars are introduced to reformulate the conditional constraints and the following continuous linear constraints (modeled with a binary variable “x”):

0≤y≤B*x, (Equation 11)

T−(1−x)B≤y≤T, and (Equation 12)

x∈{0,1}, (Equation 13)

where B is a very large scalar value, typically of the order of 100,000 or greater. Notably, when x=0 (x can only have the values of either 0 or 1 as defined by equation 13, and not any intermediate values), then the first inequality (equation 11) becomes an equality (bounded on both sides by 0, regardless of the value of B). If x=1, then the second inequality set (equation 12) becomes active with y=T (again, regardless of the value of B). In some embodiments, such reformulation techniques are also referred to as establishing a conic structure in optimization operations. In some embodiments, such reformulation techniques are also referred to as “sandwiching inequalities.”

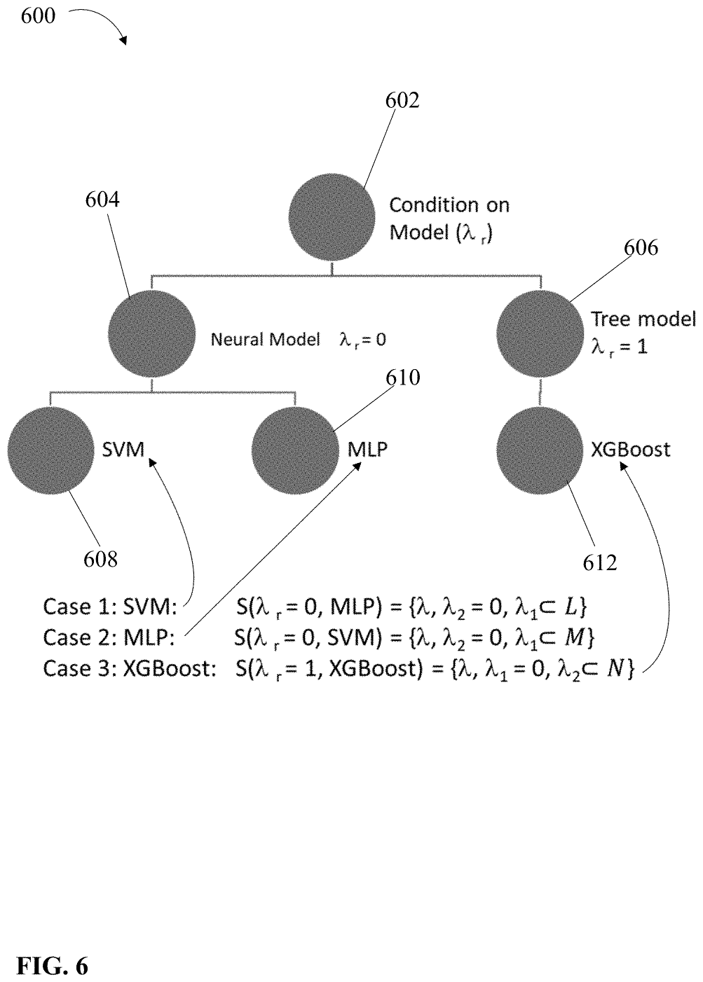

In some embodiments, the fundamental mathematical mechanisms used in the example above directed toward alleviating IF constraints are extrapolated to a multi-dimensional example. Referring to FIG. 6, a schematic diagram is presented illustrating a process 600 for multi-dimensional conditional constraint reformulation, in accordance with some embodiments of the present disclosure. A condition 602 on one of the models that populate the modeling stage 350 associated with the hyperparameter λᵣ. In one instance, the hyperparameter λᵣ is treated in a manner similar to x in equation 13, i.e., here, the neural models 604 are represented with an assigned value to the hyperparameter λᵣ of 0 and the tree models 606 are represented with an assigned value to the hyperparameter λᵣ of 1. The neural models 604 include, without limitation, Support Vector Machine (SVM) models 608 and Multi-Layer Perception (MLP) 610, and the tree models 606 include, without limitation, XGBoost 612 (as described elsewhere herein). The SVM 608 is designated Case 1 where:

S(λᵣ=0,MLP)={λ,λ₂=0,λ₁⊂L}, (Equation 14)

where L represents a larger set of hyperparameters that populate the modeling stage 350, i.e., λ₁ is a proper subset of L, which corresponds to the hyperparameters tied to MLP. λ={λ₁, λ₂} defines the vector of all hyperparameters, the dimension of which is same irrespective of the model.

Similarly, the MLP 710 is designated Case 2 where:

S(λᵣ=0,SVM)={λ,λ₂=0,λ₁⊂M}, (Equation 15)

where M represents a larger set of hyperparameters that populate the modeling stage 350, i.e., λ₁ is a proper subset of M. M defines the hyperparameter space corresponding to SVMs (in a manner similar to the notion of L defined earlier). In addition, SVM and MLP are similar in model types (though not identical) and are quite different from decision theoretic models such as XGBoost.

Further, the XGBoost 712 is designated Case 3 where:

S(λᵣ=1,XGBoost)={λ,λ₁=0,λ₂⊂N}, (Equation 16)

where M represents a larger set of hyperparameters that populate the modeling stage 350, i.e., λ₁ is a proper subset of N. N refers to the set of hyperparameters pertaining to a decision theoretic model such as XGBoost, λr=1 refers to the decision theoretic models like XGBoost as well, and λr=0 corresponds to neural models (such as MLP or SVM).

In at least some embodiments, the three Cases 1, 2, and 3 defined above are reformulated with the introduction of additional variables. The variables x, y, z, and λ retain their definitions from equation 4 above. The result is a continuous set of constraints and only binary variables as follows:

$${min}_{x , λ , d} Loss ( x , λ )$$

subject to the constraints of:

z={xᵣ,λ₁,λ₂},xᵣ={0,1} (Equation 17)

d1⊂L,d2⊂M,d3⊂N, (Equation 18)

where the expressions 17 and 18 are the associated constraints referring to the branching of possibilities of models MLP, SVM, and XGBoost denoted by hyperparameter sets L, M, and N. Here, d₁, d₂, d₃, d₄, and λ_{d} refer to the corresponding slack variables that are artificially introduced for simplicity and easier handling. Further,

d₁≤d₄≤d₁+B*λᵣ (Equation 19)

d₂−(1−λᵣ)B≤d₄≤d₂, (Equation 20)

where the constraints described in equations 19 and 20 are associated with MLP versus SVM. As described previously, the value of λᵣ determines whether decision theoretic models (e.g., XGBoost) for a value of 1 and λᵣ=0 denotes the case of neural models (i.e., SVMs or MLPs), and hence λ₁=d₄ can take either the value of d₁ (MLP) or d₂ (SVM). Note also that d₁ and d₂ are analogous to the hyperparameter sets L and M.

0≤λ₁≤B*λᵣ (Equation 21)

d₄−(1−λᵣ)*B≤λ₁≤d₄ (Equation 22)

0≤λ₂≤B*λᵣ (Equation 23)

d₃−(1−λᵣ)*B≤λ₂≤d₃, (Equation 24)

where the constraints described in equations 21-14 are associated with the choice of the model being neural (MLP or SVM) versus tree (XGBoost). Note that λ₂=0, 0≤λ₁, when λᵣ=0 (MLP or SVM) and λ₁=0, 0≤λ₂ when λᵣ=1 (XGBoost). Accordingly, conditional constraints (including IF constraints) are reformulated 506 as linear constraints.

Referring again to FIG. 5, discrete variables are reformulated 508 through nonlinear and convex reformulations. The discrete variables define a fourth complexity (complexity 4). In general, and as described further, the nonlinear and convex reformulations include convex relaxation by a log barrier function and penalties. In addition, the nonlinear and convex reformulations include categorical and other variable reformulations. The discrete values problem is defined through the following algorithm:

x,y,z∈ [symbol] ^{k1},λ∈ [symbol] ^{k2}* [symbol] ^{k3}, (Equation 25)

where the last expression denotes a cartesian product and the sets [symbol] and [symbol] refer to the space of integers and real numbers respectively, with dimensions k₁, k₂, and k₃ defined suitably (i.e., problem dependent).

In general, the execution of method step 508 to reformulate discrete variables includes two sub-steps, i.e., firstly, addressing integer variables and then, secondly, addressing more general discrete variables. Also, in general, an integer variable is given by the following expression:

z={1, . . . ,n}, (Equation 26)

where the discrete variable z is any integer value between, and including, 1 through n, and not any fraction between the integer values. As a non-limiting example, if n=3, only one of the three following statements can be true: z=1, z=2, or z=3. Note that any fractional value in between, e.g., 2.3 or 1.7 is not feasible with the given discrete constraints. Such discrete constraints are replaced by introducing binary variables as follows:

Σᵢ₌₁ⁿzᵣⁱ≤n and zᵣⁱ={0,1}, (Equation 27)

where i denotes the choice of models, and equation 27 illustrates the first sub-step of addressing integer values being met; however, now the binary variable formulation needs to be addressed. In some embodiments, the logarithmic (log) barrier method is used to reformulate the above “binary spaces” into an unconstrained optimization problem in continuous variables. For example, the following algorithm is employed:

$${𝓏}_{r}^{i} ∈ \{ 0 , 1 \} ⟹ {𝓏}_{r} ∈ arg {min}_{{𝓏}_{r}} \{ {\sum }_{i = 1}^{n} \{ {ρ𝓏}_{r}^{i} ( 1 - {𝓏}_{r}^{i} ) - μ log ( {𝓏}_{r}^{i} ( 1 - {𝓏}_{r}^{i} ) ) \} \} \qquad ( Equation 28 )$$

where the expression ρΣᵢ₌₁ⁿzᵣⁱ(1−zᵣⁱ) refers to a penalty term that penalizes the objective for any departure of z from 0 or 1. This approach tends to force z to take values of either 0 or 1 indirectly.

In some embodiments, categorical variables, which are discrete generalizations, are formulated as a sum over binary variables that are scaled accordingly. For a non-limiting example, λ={0.5, 0.7, 1.9} is reformulated as:

λ=b₁*w₁+b₂*w₂+b₃*w₃, (Equation 29)

where λ here represents a categorical hyperparameter, b₁=0.5, b₂=0.7, and b₃=1.9 are the respective coefficients, and where:

w₁+w₂+w₃=1, and w₁, . . . ,w₃∈{0,1}, (Equation 30)

where this sum over binary variables reformulation introduces some efficiencies subject to the spaces of hyperparameters and pipeline decision variables are not infinitely large, i.e., they are bounded from above by smaller integers. Accordingly, discrete variables are reformulated through the log barrier method to reformulate binary spaces into an unconstrained optimization problem with continuous variables.

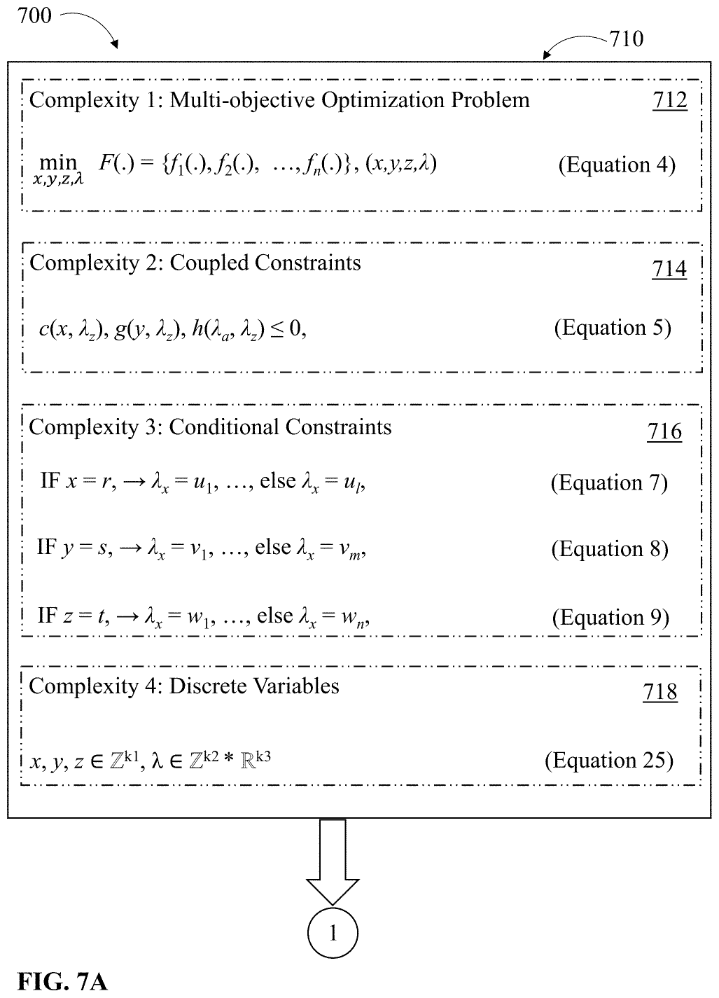

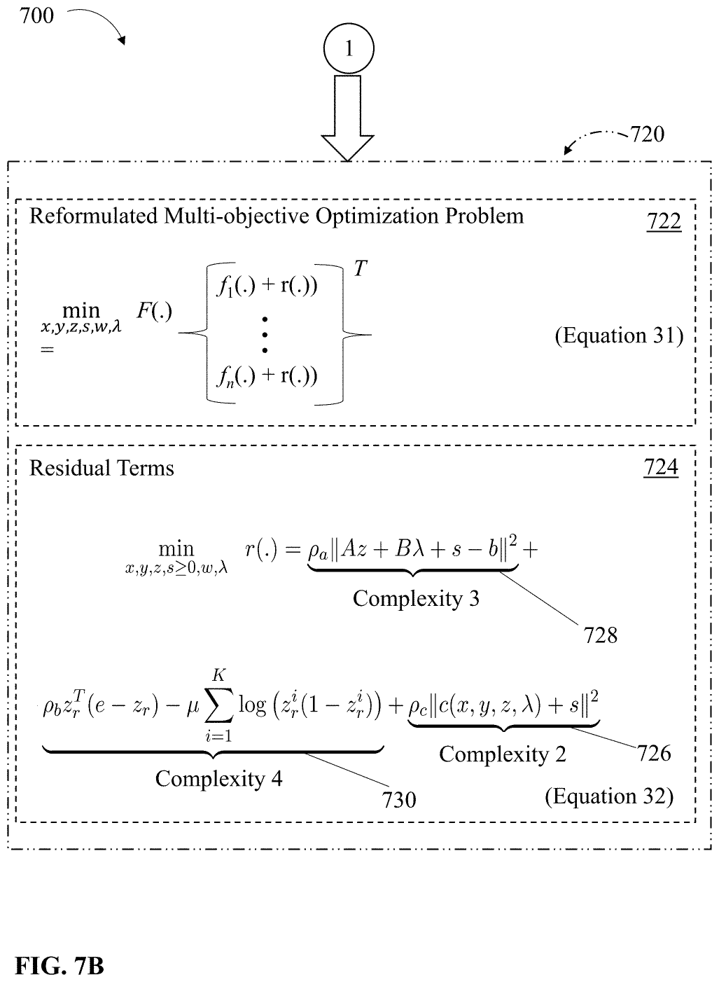

Referring again to FIG. 5, the formulation transformation is completed 510. Referring to FIG. 7A, a block schematic diagram is presented illustrating a complexity portion 710 of the process 700 for multi-dimensional conditional constraint reformulation shown in FIG. 5, through the respective mathematical algorithms, in accordance with some embodiments of the present disclosure. The first complexity 712 (Complexity 1) is defined as a multi-objective problem statement through equation 4 that is formulated to execute based on discrete variables and multiple constraints, and as discussed herein, is reformulated into a problem statement that uses continuous variables in an unconstrained manner. The second complexity 714 (Complexity 2) is defined through equation 5 that addresses coupled constants. The third complexity 716 (Complexity 3) is defined through equations 7, 8, and 9 that address conditional constraints. The fourth complexity 718 (Complexity 4) is defined through equation 25 to address the discrete variables.

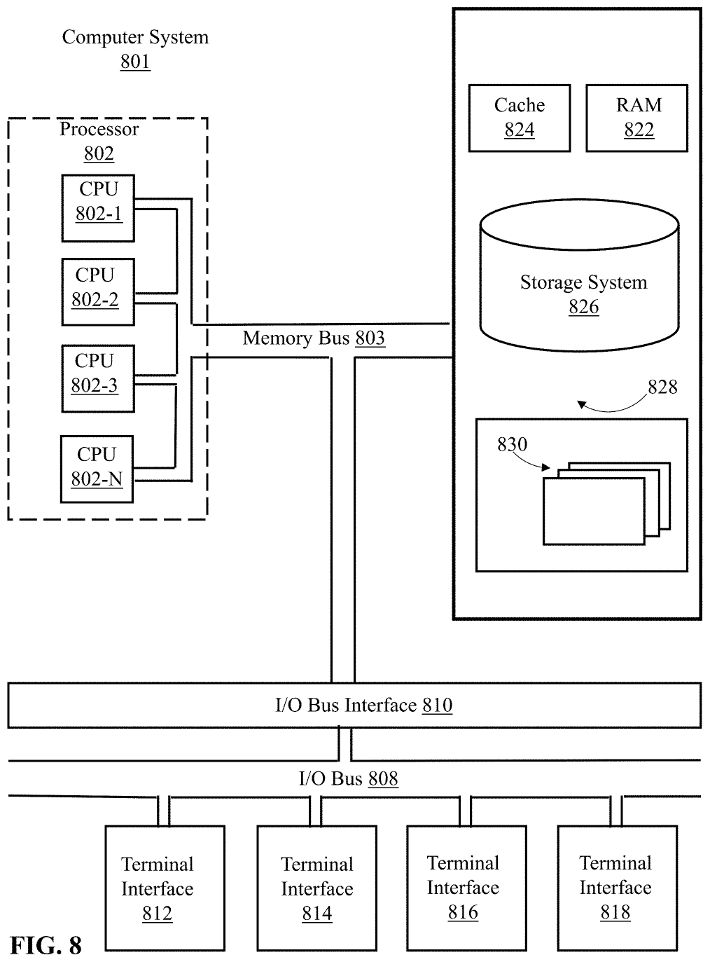

Referring FIG. 7B, a block schematic diagram is presented illustrating a constraint-relaxed and continuous variable portion 720 of the process 700 for multi-dimensional conditional constraint reformulation through the respective mathematical algorithms, in accordance with some embodiments of the present disclosure. In one or more embodiments, the discrete variable and conditional programming problem of equation 4 (see 712 of FIG. 8A), with the complexities 714, 716, and 718, is reformulated into a completely continuous problem 722 with relaxed constraints, such as:

$${min}_{x , y , z , s , w , λ} F ( . ) = {\{ \begin{matrix}( {f}_{1} ( . ) + r ( . ) ) \\ … \\ {f}_{n} ( . ) + r ( . ) )\end{matrix} \}}^{T} , \qquad ( Equation 31 )$$

where the superscript “T” refers to the transpose, and the residual terms r(·) address the individual complexities described herein, and are described through equation 32 (shown as residual terms 724 in FIG. 7B). Referencing equation 31, the reformulated multi-objective optimization problem “min F(·)” represents the optimization problem to be solved to provide the optimum tradeoff between the respective goals of minimizing (or maximizing) each fᵢ(·) within the set of fᵢ(·) through fₙ(·) by searching over the entire ML pipeline search space 138 (see FIG. 1). The optimization is to be executed over a set of values that include x, y, and z (the choices of preprocessor, feature engineering, and model indexes, respectively), the slack variable s (introduced artificially to transform the inequality constraints to equality constraints), and the hyperparameters λ. In addition, the w is artificially introduced into the formulation at a later stage to weigh objectives if required.

Referring to equation 32 (the residual terms 724), the residual r(·) is to be minimized over a set of values that include x, y, and z (the choices of preprocessor, feature engineering, and model indexes, respectively), the slack variable s that is set to ≥0, and the hyperparameters λ. The expression for the residual r(·) includes three expressions 726, 728, and 730 that represent the algorithms for each of the complexities 2, 3, and 4, respectively. For the expression 728, the “ρₐ” represents a penalty coefficient value for relaxing the coupled constraints, and the A, B, and b refer to constant matrices and vectors that formalize the equations 18-24 presented above. Similarly, for the expression 730 the “ρ_{b}” represents a penalty coefficient value for relaxing the conditional constraints, where, additionally, zᵣ=λᵣ puts forth a log barrier term to relax the binary variables λᵣ in the expression 730, and λᵣ is replaced by zᵣ for ease of notation and to go in sync with the model parameters z. Lastly, for the expression 726, the “ρ_{c}” represents a penalty coefficient value for reformulating the discrete variables to continuous variables, and c(·) denotes the coupled nonlinear constraints and s denotes slack variables. Accordingly, the unconstrained and continuous multi-objective optimization formulation through the method step 510 includes the use of the various penalties, Lagrangian relaxations, etc.

Referring again to FIG. 5, the reformulated problem expressions of equations 31 and 32 are used to execute 512 the unconstrained multi-objective optimization to optimize the collection of algorithms and hyperparameters over the ML pipeline search space 138 through a CASH optimization process similar to that described for the CASH optimization process 300. Specifically, the multi-objective CASH optimization module 536 is configured to generate one or more multi-objective optimized ML pipelines 555 (shown as 255 in FIG. 2) for a plurality of objectives that result in a set of pipelines as the Pareto-optimal solutions 249 (see FIG. 2) that are further transmitted through the GUI 206 to generate the output display of a Pareto-front with the corresponding pipelines 243 plotted thereon. See FIG. 4B for example graphical results 443 that represent Pareto-optimal solutions to the present optimization problem. The unconstrained and continuous multi-objective optimization through the method step 512 includes the use of multi-objective Bayesian optimization through one or more of the Uncertainty-Aware Search Framework for Multi-Objective Bayesian Optimization (USeMO), Max-value Entropy Search for Multi-objective Optimization (MESMO), and Non-dominated Sorting Genetic Algorithm (NGSA II).

The system and method as disclosed herein facilitates overcoming the disadvantages and limitations of known automated machine learning systems with respect to multi-objective optimization through performing multi-objective automated machine learning, and, more specifically, through identifying a plurality of machine learning pipelines as Pareto-optimal solutions to optimize a plurality of objectives.

In some embodiments, the generation of the machine learning pipelines as Pareto-optimal solutions includes a two-step process, i.e., generating a single objective CASH optimization followed by a refinement of the single objective optimization through the introduction of additional objectives such that the optimization ML pipeline for the single objective is substantially maintained, i.e., not degraded through the introduction of additional objectives. In some embodiments, the entire CASH optimization process undergoes refinement operations to refine the entire single optimization ML pipeline. Such performing multi-objective refinement over a portion of the ML pipeline, or the full ML pipeline, includes optimizing the respective data transformers, the hyperparameters, and the ML models. In some embodiments, the single objective CASH optimization process receives an optional user input through a single objective optimizer and employs that optimizer to determine the pipeline steps of the full ML pipeline, where the pipeline refinement scheme takes either the pipeline steps provided by the user or outputted by the a single objective optimizer. Accordingly, generating a single objective CASH optimization followed by a refinement through the introduction of additional objectives includes additional elements that integrate the processes described herein into a practical application that improves multi-objective optimization.

In some embodiments, a multi-objective CASH optimization process is used to perform the respective multi-objective optimization over the full ML pipeline, i.e., the full set of the data transformers, the hyperparameters, and the ML models within the ML pipeline work space. The multi-objective CASH optimization process defines a conditionally constrained multi-objective optimization problem supporting discrete decision variables representing choices for algorithm parameters and hyperparameters that is reformulated into a multi-objective optimization problem with the constraints relaxed and continuous decision variables representing the choices for algorithm parameters and hyperparameters. The constrained multi-objective optimization problem is reformulated through processes such as non-linear or convex formulation and smoothening functions like log barrier functions via penalty or augmented Lagrangian relaxations. Accordingly, generating a multi-objective CASH optimization through reformulation of the multi-objective optimization problem includes additional elements that integrate the processes described herein into a practical application that improves multi-objective optimization through facilitating employment of known Bayesian optimization processes. Such known processes are employed on a reformulated problem with relaxed constraints and continuous variables, where the complexities of the original problem formulation are broken into discrete portions to be handled individually, thereby enhancing such known Bayesian optimization processes to provide better solutions to multi-objective optimization problems with less computing resources.

In addition, the art of solving multi-objective is enhanced through aspects that include the multi-objective optimization solutions proposed herein being agnostic to the number of dimensions (i.e., objectives), the nature of the ML pipelines, the transformers, the ML models, and the structure or gradients of the objectives since the multi-objective optimization solutions are generalizable without mandating any subject matter expertise. Moreover, the multi-objective optimization solutions proposed herein are configured to execute optimization operations on “black box” objectives and or “closed-form” objectives that may be user-generated. In addition, as an improvement over known optimization systems that do not consider the full ML pipeline, including the transformers and models, many known multi-objective optimization processes have a smaller search space compared to the optimization systems disclosed herein that search through the full ML pipeline. Therefore, for the optimization systems and processes as disclosed herein, the best set of ML pipelines are determined from this large search space. Specifically, the methods disclosed herein that search over the entire ML pipeline (transformers, hyperparameters, and models) estimate a better Pareto-front compared to systems that only search over a portion of the ML pipeline. Accordingly, significant improvements to known multi-objective automated machine learning systems are realized through the present disclosure.

Referring now to FIG. 8, a block schematic diagram is provided illustrating a computing system 801 that may be used in implementing one or more of the methods, tools, and modules, and any related functions, described herein (e.g., using one or more processor circuits or computer processors of the computer), in accordance with some embodiments of the present disclosure. In some embodiments, the major components of the computer system 801 may comprise one or more CPUs 802, a memory subsystem 804, a terminal interface 812, a storage interface 816, an I/O (Input/Output) device interface 814, and a network interface 818, all of which may be communicatively coupled, directly or indirectly, for inter-component communication via a memory bus 803, an I/O bus 808, and an I/O bus interface unit 810.

The computer system 801 may contain one or more general-purpose programmable central processing units (CPUs) 802-1, 802-2, 802-3, 802-N, herein collectively referred to as the CPU 802. In some embodiments, the computer system 801 may contain multiple processors typical of a relatively large system; however, in other embodiments the computer system 801 may alternatively be a single CPU system. Each CPU 802 may execute instructions stored in the memory subsystem 804 and may include one or more levels of on-board cache.

System memory 804 may include computer system readable media in the form of volatile memory, such as random access memory (RAM) 822 or cache memory 824. Computer system 801 may further include other removable/non-removable, volatile/non-volatile computer system storage media. By way of example only, storage system 826 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 804 can include flash memory, e.g., a flash memory stick drive or a flash drive. Memory devices can be connected to memory bus 803 by one or more data media interfaces. The memory 804 may include at least one program product having a set (e.g., at least one) of program modules that are configured to carry out the functions of various embodiments.

Although the memory bus 803 is shown in FIG. 8 as a single bus structure providing a direct communication path among the CPUs 802, the memory subsystem 804, and the I/O bus interface 810, the memory bus 803 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 810 and the I/O bus 808 are shown as single respective units, the computer system 801 may, in some embodiments, contain multiple I/O bus interface units 810, multiple I/O buses 808, or both. Further, while multiple I/O interface units are shown, which separate the I/O bus 808 from various communications paths running to the various I/O devices, in other embodiments some or all of the I/O devices may be connected directly to one or more system I/O buses.

In some embodiments, the computer system 801 may be a multi-user mainframe computer system, a single-user system, or a server computer or similar device that has little or no direct user interface, but receives requests from other computer systems (clients). Further, in some embodiments, the computer system 801 may be implemented as a desktop computer, portable computer, laptop or notebook computer, tablet computer, pocket computer, telephone, smart phone, network switches or routers, or any other appropriate type of electronic device.

It is noted that FIG. 8 is intended to depict the representative major components of an exemplary computer system 801. In some embodiments, however, individual components may have greater or lesser complexity than as represented in FIG. 8, components other than or in addition to those shown in FIG. 8 may be present, and the number, type, and configuration of such components may vary.

One or more programs/utilities 828, each having at least one set of program modules 830 may be stored in memory 804. The programs/utilities 828 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 828 and/or program modules 830 generally perform the functions or methodologies of various embodiments.

It is to be understood that although this disclosure includes a detailed description on cloud computing, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows.

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

A cloud computing environment is service oriented with a focus on statelessness, low coupling, modularity, and semantic interoperability. At the heart of cloud computing is an infrastructure that includes a network of interconnected nodes. The system 501 may be employed in a cloud computing environment.

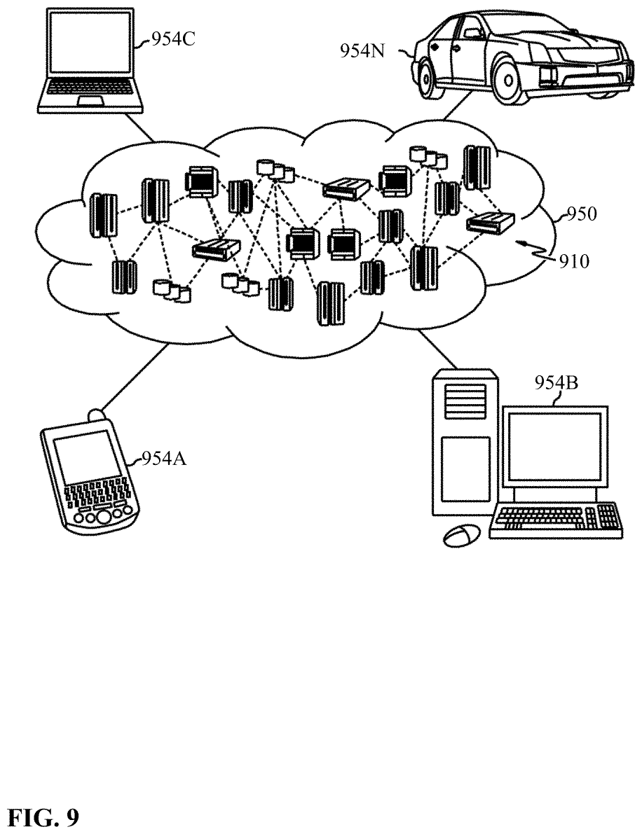

Referring to FIG. 9, a schematic diagram is provided illustrating a cloud computing environment 950, in accordance with some embodiments of the present disclosure. As shown, cloud computing environment 950 comprises one or more cloud computing nodes 99 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 may communicate with any type of computerized device over any type of network and/or network addressable connection (e.g., using a web browser).

Referring to FIG. 10, a schematic diagram is provided illustrating a set of functional abstraction model layers provided by the cloud computing environment 1050 (FIG. 10), in accordance with some embodiments of the present disclosure. It should be understood in advance that the components, layers, and functions shown in FIG. 10 are intended to be illustrative only and embodiments of the disclosure are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067 and database software 1068.

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and Pricing 1082 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Examples of workloads and functions which may be provided from this layer include: mapping and navigation 1091; software development and lifecycle management 1092; layout detection 1093; data analytics processing 1094; transaction processing 1095; and to performing multi-objective automated machine learning 1096.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for performing multi-objective automated machine learning comprising:
one or more processing devices;
one or more memory devices communicatively and operably coupled to the one or more processing devices;
a multi-objective joint optimization engine, at least partially resident within the one or more memory devices, configured to:
select two or more objectives from a plurality of objectives to be optimized;
inject data and the two or more objectives into a first machine learning (ML) pipeline, wherein the first ML pipeline includes one or more data transformation stages in communication with a modeling stage; and
execute, subject to the injecting, optimization of the two or more objectives, comprising:
select a respective algorithm for each of the one or more data transformation stages and the modeling stage, wherein each respective algorithm is associated with a first set of respective hyperparameters;
generate, subject to the selecting, a plurality of second ML pipelines, wherein each second ML pipeline of the plurality of second ML pipelines defines a Pareto-optimal solution of the two or more objectives, thereby defining a plurality of Pareto-optimal solutions; and
select one Pareto-optimal solution from the plurality of Pareto-optimal solutions.

2. The system of claim 1, wherein the multi-objective joint optimization engine is further configured to:
select one or more of:
one or more black box objectives; and
one or more closed-form objectives.

3. The system of claim 1, further comprising a single objective optimizer, wherein the multi-objective joint optimization engine is further configured to:
select a first objective from the two or more objectives;
inject the data and the first objective into the first ML pipeline, wherein the first ML pipeline is resident within the single objective optimizer, the multi-objective joint optimization engine is further configured to:
generate a third ML pipeline that optimizes the first objective comprising:
execute the selection of the respective algorithm for each of the one or more data transformation stages and the modeling stage, wherein each respective algorithm is associated with the first set of respective hyperparameters; and
refine, subject to return of the third ML pipeline from the single objective optimizer, the third ML pipeline, the multi-objective joint optimization engine is further configured to:
select a second objective from the two or more objectives; and
select, for the each of the respective algorithms for the one or more data transformation stages and the modeling stage, a respective second set of hyperparameters.

4. The system of claim 1, wherein the multi-objective joint optimization engine is further configured to:
select a first objective from the two or more objectives;
inject the data and the first objective into a user-selected ML pipeline, wherein the user-selected ML pipeline optimizes the first objective, wherein the user-selected ML pipeline includes the respective algorithm for each of the one or more data transformation stages and the modeling stage, wherein each respective algorithm is associated with the first set of respective hyperparameters; and
refine the user-selected ML pipeline, wherein the multi-objective joint optimization engine is further configured to:
select a second objective from the two or more objectives; and
select, for the each of the respective algorithms for the one or more data transformation stages and the modeling stage, a respective second set of hyperparameters.

5. The system of claim 1, wherein the multi-objective joint optimization engine is further configured to:
execute one or more single objective combined algorithm selection and hyperparameter (CASH) optimization operations.

6. The system of claim 1, wherein the multi-objective joint optimization engine is further configured to:
formulate a multi-objective optimization problem with one or more constraints and one or more discrete variables;
reformulate the multi-objective optimization problem with one or more relaxed constraints and one or more continuous variables; and
execute, subject to the reformulation, the optimization of the two or more objectives.

7. The system of claim 6, wherein the multi-objective joint optimization engine is further configured to:
reformulate coupled constraints through executing augmented Lagrangian formulations through one or more of associated penalties and relaxations of constraints.

8. The system of claim 6, wherein the multi-objective joint optimization engine is further configured to:
reformulate conditional constraints through executing operations comprising sandwiching inequalities.

9. The system of claim 6, wherein the multi-objective joint optimization engine is further configured to:
reformulate discrete variables through executing operations comprising log barrier methods to reformulate binary spaces into an unconstrained optimization problem with continuous variables.

10. A computer program product embodied on at least one computer readable storage medium having computer executable instructions for performing multi-objective automated machine learning, that when executed cause one or more computing devices to:
select two or more objectives from a plurality of objectives to be optimized;
inject data and the two or more objectives into a first machine learning (ML) pipeline, wherein the first ML pipeline includes one or more data transformation stages in communication with a modeling stage; and
execute, subject to the injecting, optimization of the two or more objectives, comprising:
select a respective algorithm for each of the one or more data transformation stages and the modeling stage, wherein each respective algorithm is associated with a first set of respective hyperparameters;
generate, subject to the selecting, a plurality of second ML pipelines, wherein each second ML pipeline of the plurality of second ML pipelines defines a Pareto-optimal solution of the two or more objectives, thereby defining a plurality of Pareto-optimal solutions; and
select one Pareto-optimal solution from the plurality of Pareto-optimal solutions.

11. The computer program product of claim 10, further having computer executable instructions to execute one of:
refine an ML pipeline generated through a single objective optimizer; and
reformulate a multi-objective optimization problem formulated with one or more constraints and one or more discrete variables with one or more relaxed constraints and one or more continuous variables.

12. A computer-implemented method for performing multi-objective automated machine learning comprising:
selecting two or more objectives from a plurality of objectives to be optimized;
injecting data and the two or more objectives into a first machine learning (ML) pipeline, wherein the first ML pipeline includes one or more data transformation stages in communication with a modeling stage; and
executing, subject to the injecting, optimization of the two or more objectives, comprising:
selecting a respective algorithm for each of the one or more data transformation stages and the modeling stage, wherein each respective algorithm is associated with a first set of respective hyperparameters;
generating, subject to the selecting, a plurality of second ML pipelines, wherein each second ML pipeline of the plurality of second ML pipelines defines a Pareto-optimal solution of the two or more objectives, thereby defining a plurality of Pareto-optimal solutions; and
selecting one Pareto-optimal solution from the plurality of Pareto-optimal solutions.

13. The method of claim 12, wherein the selecting two or more objectives comprises:
selecting one or more of:
one or more black box objectives; and
one or more closed-form objectives.

14. The method of claim 12, wherein the executing optimization of the two or more objectives further comprises:
selecting a first objective from the two or more objectives;
injecting the data and the first objective into the first ML pipeline, wherein the first ML pipeline is resident within a single objective optimizer, thereby generating a third ML pipeline that optimizes the first objective comprising:
the selecting the respective algorithm for each of the one or more data transformation stages and the modeling stage, wherein each respective algorithm is associated with the first set of respective hyperparameters; and
refining, subject to return of the third ML pipeline from the single objective optimizer, the third ML pipeline comprising:
selecting a second objective from the two or more objectives; and
selecting, for the each of the respective algorithms for the one or more data transformation stages and the modeling stage, a respective second set of hyperparameters.

15. The method of claim 12, wherein the executing optimization of the two or more objectives further comprises:
selecting a first objective from the two or more objectives;
injecting the data and the first objective into a user-selected ML pipeline, wherein the user-selected ML pipeline optimizes the first objective, wherein the user-selected ML pipeline includes the respective algorithm for each of the one or more data transformation stages and the modeling stage, wherein each respective algorithm is associated with the first set of respective hyperparameters; and
refining the user-selected ML pipeline comprising:
selecting a second objective from the two or more objectives; and
selecting, for the each of the respective algorithms for the one or more data transformation stages and the modeling stage, a respective second set of hyperparameters.

16. The method of claim 12, further comprising:
executing one or more single objective combined algorithm selection and hyperparameter (CASH) optimization operations.

17. The method of claim 12, wherein the executing optimization of the two or more objectives further comprises:
formulating a multi-objective optimization problem with one or more constraints and one or more discrete variables;
reformulating the multi-objective optimization problem with one or more relaxed constraints and one or more continuous variables; and
executing, subject to the reformulating, the optimization of the two or more objectives.

18. The method of claim 17, wherein the reformulating the multi-objective optimization problem comprises:
reformulating coupled constraints through executing augmented Lagrangian formulations through one or more of associated penalties and relaxations of constraints.

19. The method of claim 17, wherein the reformulating the multi-objective optimization problem comprises:
reformulating conditional constraints through executing operations comprising sandwiching inequalities.

20. The method of claim 17, wherein the reformulating the multi-objective optimization problem comprises:
reformulating discrete variables through executing operations comprising log barrier methods to reformulate binary spaces into an unconstrained optimization problem with continuous variables.
